(19) United States
(12) Patent Application Publication
(10) Pub. No.: US 2021/0248107 A1
(43) Pub. Date: Aug. 12, 2021

(54) KV STORAGE DEVICE AND METHOD OF USING KV STORAGE DEVICE TO PROVIDE FILE SYSTEM

(71) Applicant: BEIJING MEMBLAZE TECHNOLOGY CO., LTD, Beijing (CN)

(72) Inventors: Junwei HOU, Beijing (CN); Bing TIAN, Beijing (CN)

(21) Appl. No.: 17/044,432

(22) PCT Filed: Jun. 28, 2018
(86) PCT No.: PCT/CN2018/093285

§ 371 Date: Oct. 1, 2020

(30) Foreign Application Priority Data
Dec. 29, 2017 (CN) 201711474660.3
Dec. 29, 2017 (CN) 201711477442.5

(51) Int. Cl. G06F 16/14; G06F 16/16; G06F 12/02; G06F 12/1018

(52) U.S. Cl. CPC G06F 16/152; G06F 16/162; G06F 2212/7201; G06F 12/1018; G06F 12/0238

(57) ABSTRACT

The present application provides a KV storage device and a method of using a KV storage device to provide a file system. The provided method for a KV storage device includes: receiving a logical key for accessing a KV storage device; acquiring a physical key corresponding to the logical key; and querying an address translation table to obtain an address corresponding to the physical key, wherein a value corresponding to the logical key is stored in the address.

### CROSS REFERENCE TO RELATED APPLICATIONS

The present application claims priority to Chinese Patent Application No. 2017114774425, filed on Dec. 29, 2017 and entitled “METHOD OF USING KV STORAGE DEVICE TO PROVID FILE SYSTEM AND FILE SYSTEM THEREOF”, and Chinese Patent Application No. 2017114746603, filed on Dec. 29, 2017 and entitled “KV STORAGE DEVICE FOR PROVIDING LOGICAL KEYS AND METHOD THEREOF”, which are incorporated herein by reference in their entirety.

### TECHNICAL FIELD

The present application relates to a KV storage device, and in particular, to a KV storage device and a method of using a KV storage device to provide a file system.

### BACKGROUND

FIG. 1A shows a block diagram of a solid-state storage device. The solid-state storage device 102 is coupled with a host to provide storage capabilities for the host. The host and the solid-state storage device 102 can be coupled with each other in a variety of ways, including, but not limited to, connecting the host to the solid-state storage device 102 through, for example, a Serial Advanced Technology Attachment (SATA), a Small Computer System Interface (SCSI), a Serial Attached SCSI (SAS), Integrated Drive Electronics (IDE), a Universal Serial Bus (USB), Peripheral Component Interconnect Express (PCIE), Non-Volatile Memory Express (NVM Express, NVMe), the Ethernet, a fiber channel, a wireless communication network, and the like. The host may be an information processing device capable of communicating with the storage device in the above-mentioned ways, such as, a personal computer, a tablet computer, a server, a portable computer, a network switch, a router, a cellular phone, and a personal digital assistant. The storage device 102 includes an interface 103, a control component 104, one or more NVM chips 105, and a Dynamic Random Access Memory (DRAM) 110.

NAND flash memory, phase change memory, Ferroelectric RAM (FeRAM), Magnetic Random Access Memory (MRAM), Resistive Random Access Memory (RRAM), etc. are common NVMs.

The interface 103 can be adapted to exchange data with the host by means of, for example, SATA, IDE, USB, PCIE, NVMe, SAS, the Ethernet, a fiber channel and the like.

The control component 104 is configured to control data transmission among the interface 103, the NVM chip 105 and the DRAM 110, and is further configured for storage management, mapping from a logical address of the host to a physical address of the flash memory, erasure leveling, bad block management, and the like. The control component 104 can be implemented in multiple ways such as software, hardware, firmware, or a combination thereof. For example, the control component 104 may be a Field-programmable gate array (FPGA), an Application Specific Integrated Circuit (ASIC), or a combination thereof. The control component 104 may also include a processor or a controller, and the software is executed in the processor or controller to manipulate the hardware of the control component 104 to process Input/Output (IO) commands. The control unit 104 may also be coupled to the DRAM 110 and can access data of the DRAM 110. The DRAM may store an FTL table and/or cached data of the IO commands.

The control component 104 includes a flash memory interface controller (or called a media interface controller or a flash memory channel controller). The flash memory interface controller is coupled to the NVM chip 105, and issues a command to the NVM chip 105 by means of following the interface protocol of the NVM chip 105 to operate the NVM chip 105, and receives the command execution result output from the NVM chip 105. Known NVM chip interface protocols include “Toggle”, “ONFI”, and the like.

A memory target is one or more logic units (LUN, Logic UNit) sharing a Chip Enable (CE) signal in a NAND flash memory package. The NAND flash memory package may include one or more dies. Typically, the logic unit corresponds to a single die. The logic unit may include multiple planes. The multiple planes in the logic unit can be accessed in parallel, and the multiple logic units in the NAND flash memory chip can execute commands and report status independently of each other.

Data is usually stored and read on the storage medium in pages. However, the data is erased in blocks. A block (also called a physical block) includes multiple pages. The pages (called physical pages) on the storage medium have a fixed size, for example, 17,664 bytes. The physical pages may also have other sizes.

In the solid-state storage device, a Flash Translation Layer (FTL) is used to maintain mapping information from a logical address to a physical address. The logical address constitutes a storage space of the solid-state storage device as perceived by upper-layer software such as an operating system. The physical address is an address used for accessing a physical storage unit of the solid-state storage device. In the related art, an intermediate address form can also be used to implement address mapping. For example, the logical address is mapped to the intermediate address, and then the intermediate address is further mapped to the physical address.

A table structure which stores the mapping information from the logical address to the physical address is called an FTL table. The FTL table is important metadata in the solid-state storage device. Generally, data items of the FTL table record address mapping relationships in the solid-state storage device in units of data pages.

The FTL table includes multiple FTL table entries (or called table items). In one case, each FTL table entry records the corresponding relationship between one logical page address and one physical page. In another case, each FTL table entry records the corresponding relationship between multiple consecutive logical page addresses and multiple consecutive physical pages. In yet another case, each FTL table entry records the corresponding relationship between the logical block address and the physical block address. In still another case, the FTL table records the mapping relationship between the logical block address and the physical block address, and/or the mapping relationship between the logical page address and the physical page address.

In “DFTL: A Flash Translation Layer Employing Demand-based Selective Caching of Page-level Address Mappings”, an improved FTL table method and the application thereof in a solid-state storage device are disclosed, and the entire text thereof can be obtained from http://www.cse.psu.edu/˜buul/papers/ps/dftl-asplos09.pdf.

A storage device that supports a Key-Value (Key-Data, also referred to as “KV”) storage model provides a key-based read operation (Get (Key)) and write operation (Put (Key, Value)). In order to execute the write operation, the host provides a key (Key) and data (Value) to the storage device to write the data into the storage device, and takes the key as an index of the written data. In order to execute the read operation, the host provides a key to the storage device, and the storage device finds data according to the key and provides the data to the host. Therefore, in the KV storage system, the key is the index used for accessing the data, and the data (Value) is the accessed data. Generally, neither of the lengths of the key and the data is a fixed length. Moreover, optionally, in order to reduce complexity, the lengths of the key and/or the data may have a specified range.

FIG. 1B shows a schematic diagram of an address translation system of a solid-state storage device in the prior art. The address translation system (also referred to as an FTL table) of the solid-state storage device supporting a KV storage model provides mapping from a key to an address (such as, a Physical Page Address (PPA), or a logical address). Optionally, in addition to the physical page address, the physical address recorded in the FTL table may be the start address of a data frame inside the physical page. The data frame is a data unit having a fixed size, and the physical page includes one or more data frames. The logical address recorded in the FTL table is, for example, a logical address serving as an index in another FTL table.

For some KV storage devices, the length of the key provided by the host is variable, and the length of the data is also variable. The key serves as the index of the FTL table. The key is taken as an index to query the FTL table to obtain a corresponding address. The FTL table may be realized by various data structures such as arrays, link tables, and trees. Optionally, performing a hash calculation on the variable-length key to obtain a fixed-length hash key (for example, 4 bytes/8 bytes), which is taken as the index of the FTL table.

### SUMMARY

Operations provided by a KV storage device include, for example, a read operation (Get (Key)), a write operation (Put (Key, Value)), and a delete operation (Delete (Key)). However, there are other operation requirements for the data in applications, including, but not limited to, a modification operation for the key itself, copy operations for the key and its data, a query (or read) operation for the key and its data belonging to a certain range, and the like. These operations are difficult to be provided by the KV storage devices in the prior art. The file system provides mappings from, for example, file names to addresses of storage devices. By using KV storage devices, file system services can be provided more efficiently.

According to a first aspect of the present application, provided is a first method of using a KV storage device to provide a file system according to the first aspect of the present application, including: acquiring a file system path of a file system object to be accessed; acquiring a key (K) corresponding to the file system path; and accessing a value (V) corresponding to the key (K) in a KV storage device by using the key (K), wherein the value is an object corresponding to the file system path in the file system.

According to the first method of using a KV storage device to provide a file system according to the first aspect of the present application, provided is a second method of using a KV storage device to provide a file system according to the first aspect of the present application, wherein the file system maintains a sorted table, and acquires the key (K) corresponding to the file system path through the sorted table.

According to the first method of using a KV storage device to provide a file system according to the first aspect of the present application, provided is a third method of using a KV storage device to provide a file system according to the first aspect of the present application, wherein the KV storage device provides a sorted table, and the file system obtains the key (K) corresponding to the file system path by accessing the sorted table of the KV storage device.

According to the first or second method of using a KV storage device to provide a file system according to the first aspect of the present application, provided is a fourth method of using a KV storage device to provide a file system according to the first aspect of the present application, wherein the KV storage device provides the sorted table with a storage service of <key (K), value (V)>, wherein the file system path recorded in an entry of the sorted table is used as the key (K) of the KV storage device, and the key corresponding to the file system path recorded in the entry of the sorted table is used as the value (V) of the KV storage device.

According to one of the first to third methods of using a KV storage device to provide a file system according to the first aspect of the present application, provided is a fifth method of using a KV storage device to provide a file system according to the first aspect of the present application, wherein the object of the file system includes file content and directory content; the directory content includes keys (K) and names of subdirectories contained in the directory, and keys (K) and names of files contained therein; and the method further includes: acquiring a first directory where the to-be-accessed file system object is located by means of the file system path; and accessing the directory content of the first directory from the KV storage device through the key (K) of the first directory, and acquiring the key (K) of the file system object to be accessed from the directory content of the first directory.

According to one of the first to third methods of using a KV storage device to provide a file system according to the first aspect of the present application, provided is a sixth method of using a KV storage device to provide a file system according to the first aspect of the present application, wherein the object of the file system include file content, directory metadata, and directory attribute content; the directory metadata includes keys (K) of subdirectories contained in the directory, and keys (K) of files contained therein; the directory metadata includes names of the subdirectories contained in the directory and names of the files contained therein; and the method further includes: acquiring a first directory where the file system object to be accessed is located by means of the file system path; acquiring a key of the directory metadata of the first directory and a key of a directory attribute of the first directory through the key (K) of the first directory; and accessing the directory metadata and the directory attribute of the first directory from the KV storage device to acquire the key (K) of the file system object to be accessed.

According to the fifth or sixth method of using a KV storage device to provide a file system according to the first aspect of the present application, provided is a seventh method of using a KV storage device to provide a file system according to the first aspect of the present application, wherein the object of the file system is stored in the KV storage device as the value (V).

According to the fifth method of using a KV storage device to provide a file system according to the first aspect of the present application, provided is an eighth method of using a KV storage device to provide a file system according to the first aspect of the present application, further including: in response to creating a file in the file system, assigning a key (K) for the KV storage device to the file to be created, and recording the key (K) assigned to the file to be created and the name of the file to be created in the directory content of the first directory.

According to the fifth or eighth method of using a KV storage device to provide a file system according to the first aspect of the present application, provided is a ninth method of using a KV storage device to provide a file system according to the first aspect of the present application, including in response to modifying the name of the file system object in the file system, updating the name of the file system object to be modified recorded in the directory content of the first directory.

According to the fifth, eighth or ninth method of using a KV storage device to provide a file system according to the first aspect of the present application, provided is a tenth method of using a KV storage device to provide a file system according to the first aspect of the present application, further including: in response to deleting a directory in the file system, deleting all subdirectories of the directory to be deleted, acquiring the keys (K) of all files contained in the directory to be deleted from the content of the directory of the directory to be deleted, using the acquired keys (K) to delete the corresponding file content from the KV storage device, and delete an entry corresponding to the directory to be deleted recorded in the content of the directory of the first directory.

According to one of the fifth and eighth to tenth methods of using a KV storage device to provide a file system according to the first aspect of the present application, provided is an eleventh method of using a KV storage device to provide a file system according to the first aspect of the present application, further including: in response to reading a file in the file system, querying an entry corresponding to the name of the file to be read in the directory content of the first directory, acquiring the key (K) of the file to be read from the entry, and reading the corresponding file content from the KV storage device according to the acquired key (K).

According to the sixth method of using a KV storage device to provide a file system according to the first aspect of the present application, provided is a twelfth method of using a KV storage device to provide a file system according to the first aspect of the present application, further including: in response to creating a file in the file system, assigning a key (K) for the KV storage device to the file to be created, recording the key (K) assigned to the file to be created in the directory metadata of the first directory, and recording the name of the file to be created in the directory attribute content of the first directory.

According to the sixth or twelfth method of using a KV storage device to provide a file system according to the first aspect of the present application, provided is a thirteenth method of using a KV storage device to provide a file system according to the first aspect of the present application, further including: in response to modifying the name of the file system object in the file system, updating the name of the file system object to be modified recorded in the directory attribute content of the first directory.

According to the sixth, twelfth or thirteenth method of using a KV storage device to provide a file system according to the first aspect of the present application, provided is a fourteenth method of using a KV storage device to provide a file system according to the first aspect of the present application, further including: in response to deleting a directory in the file system, deleting all subdirectories of the directory to be deleted, acquiring the keys (K) of all files contained in the directory to be deleted from the directory metadata of the directory to be deleted, using the acquired keys (K) to delete the corresponding file content from the KV storage device, and delete an entry corresponding to the directory to be deleted recorded in the directory metadata and the directory attribute content of the first directory.

According to one of the sixth and twelfth to fourteenth methods of using a KV storage device to provide a file system according to the first aspect of the present application, provided is a fifteenth method of using a KV storage device to provide a file system according to the first aspect of the present application, further including: in response to reading a file in the file system, querying an entry corresponding to the name of the file to be read in the directory attribute content and the directory metadata of the first directory, acquiring the key (K) of the file to be read from the entry, and reading the corresponding file content from the KV storage device according to the acquired key (K).

According to one of the fifth to fifteenth methods of using a KV storage device to provide a file system according to the first aspect of the present application, provided is a sixteenth method of using a KV storage device to provide a file system according to the first aspect of the present application, further including: compared with the acquisition of the first directory, the key (K) of the file system object to be accessed is obtained first through the sorted table.

According to the sixth method of using a KV storage device to provide a file system according to the first aspect of the present application, provided is a seventeenth method of using a KV storage device to provide a file system according to the first aspect of the present application, further including: in response to modifying the name of the file system object, locking the entry corresponding to the file system path associated with the file system object to be modified in the sorted table.

According to the sixth method of using a KV storage device to provide a file system according to the first aspect of the present application, provided is an eighteenth method of using a KV storage device to provide a file system according to the first aspect of the present application, further including: in response to modifying the name of the file system object, locking the sorted table.

According to the seventeenth or eighteenth method of using a KV storage device to provide a file system according to the first aspect of the present application, provided is a nineteenth method of using a KV storage device to provide a file system according to the first aspect of the present application, further including: updating the file system path of one or more entries associated with the modified file system object recorded in the sorted table.

According to the nineteenth method of using a KV storage device to provide a file system according to the first aspect of the present application, provided is a twentieth method of using a KV storage device to provide a file system according to the first aspect of the present application, further including: in response to the completion of the update of the sorted table, releasing the added lock.

According to one of the seventeenth to twentieth methods of using a KV storage device to provide a file system according to the first aspect of the present application, provided is a twenty-first method of using a KV storage device to provide a file system according to the first aspect of the present application, further including: in response to accessing the object of the file system, if the file system path of the object to be accessed is locked in the file system, accessing the first directory from the KV storage device to obtain the key (K) of the file system object to be accessed.

According to a second aspect of the present application, provided is a first file system according to the second aspect of the present application, including a program stored in a computer readable medium, wherein when the program is executed by a processor, one of the first to twenty-first method of using a KV storage device to provide a file system according to the first aspect of the present application is implemented.

According to the first file system according to the second aspect of the present application, provided is a second file system according to the second aspect of the present application, wherein the second file system is coupled to the KV storage device.

According to the first file system according to the second aspect of the present application, provided is a third file system according to the second aspect of the present application, wherein the second file system is implemented on the KV storage device.

According to a third aspect of the present application, provided is a first method for a KV storage device according to the third aspect of the present application, including: receiving a logical key (LK) for accessing a KV storage device; acquiring a physical key (PK) corresponding to the logical key (LK); and querying an address translation table to obtain an address corresponding to the physical key (PK), wherein a value (V) corresponding to the logical key (LK) is stored in the address.

According to the first method for a KV storage device according to the third aspect of the present application, provided is a second method for a KV storage device according to the third aspect of the present application, wherein a first table of the KV storage device is queried to acquire the physical key (PK) corresponding to the logical key (LK).

According to the second method for a KV storage device according to the third aspect of the present application, provided is a third method for a KV storage device according to the third aspect of the present application, wherein the first table is a sorted table.

According to the third method for a KV storage device according to the third aspect of the present application, provided is a fourth method for a KV storage device according to the third aspect of the present application, wherein the sorted table is implemented with a prefix tree.

According to one of the first to third methods for a KV storage device according to the third aspect of the present application, provided is a fifth method for a KV storage device according to the third aspect of the present application, wherein performing a hash calculation on the physical key (PK) to obtain a hash key (HPK); and accessing a hash table with the hash key (HPK) as an index, to obtain the address corresponding to the physical key (PK).

According to the fifth method for a KV storage device according to the third aspect of the present application, provided is a sixth method for a KV storage device according to the third aspect of the present application, wherein the first hash table is queried according to a first part (HPK1) of the hash key; and if the entry corresponding to the first part (HPK1) of the hash key in the first hash table records a physical address corresponding to the value (V) of the logical key (LK), first data is read from a storage medium according to the physical address.

According to the sixth method for a KV storage device according to the third aspect of the present application, provided is a seventh method for a KV storage device according to the third aspect of the present application, wherein if the entry corresponding to the first part (HPK1) of the hash key in the first hash table records the address of a second hash table, the second hash table is queried according to a second part (HPK2) of the hash key.

According to the sixth or seventh method for a KV storage device according to the third aspect of the present application, provided is an eighth method for a KV storage device according to the third aspect of the present application, wherein if the first part (HPK1) of the hash key has no corresponding entry in the first hash table, it indicates that the logical key (LK) does not exist in the KV storage device.

According to one of the sixth to eighth methods for a KV storage device according to the third aspect of the present application, provided is a ninth method for a KV storage device according to the third aspect of the present application, wherein the length of the first part (HPK1) of the hash key is less than the length of the hash key (HPK); and the length of the second part (HPK1) of the hash key is less than the length of the hash key (HK).

According to one of the sixth to ninth methods for a KV storage device according to the third aspect of the present application, provided is a tenth method for a KV storage device according to the third aspect of the present application, wherein the first data is stored at the address; a first key (Kp) is acquired from the first data; and if the first key (Kp) matches the logical key (LK) or the physical key (K), the value (V) acquired from the first data is adopted to respond to the logical key (LK) used to access the KV storage device.

According to the seventh method for a KV storage device according to the third aspect of the present application, provided is an eleventh method for a KV storage device according to the third aspect of the present application, further including: if the entry corresponding to the second part (HPK2) of the hash key in the second hash table records the physical address corresponding to the value (V) of the logical key (LK), the second data is read from the storage medium according to the physical address.

According to one of the seventh to eleventh methods for a KV storage device according to the third aspect of the present application, provided is a twelfth method for a KV storage device according to the third aspect of the present application, further including: acquiring the length of the first key (Kp) from the entry corresponding to the first part (HPK1) of the hash key in the first hash table, and comparing the length of the first key (Kp) with the length of the logical key (LK) or the physical key (K) to identify whether or not the first key (Kp) matches the logical key (LK) or the physical key (K).

According to one of the first to twelfth methods for a KV storage device according to the third aspect of the present application, provided is a thirteenth method for a KV storage device according to the third aspect of the present application, wherein in response to writing the value (V) corresponding to the logical key (LK) into the KV storage device, if the physical key (PK) corresponding to the logical key (LK) is not found in the first table, the physical key (PK) is assigned to the logical key, an entry is added to the first table to record that the logical key (LK) corresponds to the assigned physical key (PK), and an address is assigned to the assigned physical key (PK); and an entry is added to the address translation table to record the physical key (PK) and the assigned address, and the value (V) corresponding to the logical key (LK) is written at the assigned address.

According to the thirteenth method for a KV storage device according to the third aspect of the present application, provided is a fourteenth method for a KV storage device according to the third aspect of the present application, wherein in response to instructing the KV storage device to modify the logical key (LK), an entry corresponding to the logical key (LK) is found in the first table, and the entry is modified to record the modified new logical key.

According to the fourteenth method for a KV storage device according to the third aspect of the present application, provided is a fifteenth method for a KV storage device according to the third aspect of the present application, wherein if the entry corresponding to the logical key (LK) is not found in the first table, it indicates that an error occurs.

According to one of the thirteenth to fifteenth methods for a KV storage device according to the third aspect of the present application, provided is a sixteenth method for a KV storage device according to the third aspect of the present application, wherein in response to instructing the KV storage device to copy the value (V) corresponding to the logical key (LK), a first physical key (PK) corresponding to the logical key (LK) is found in the first table, and an entry is added to the first table to record that the new logical key corresponds to the first physical key (PK).

According to one of the thirteenth to sixteenth methods for a KV storage device according to the third aspect of the present application, provided is a seventeenth method for a KV storage device according to the third aspect of the present application, wherein in response to instructing the KV storage device to read all values of a logical key range (LK_R), the physical key (PK) corresponding to one or more logical keys (LK) falling within the logical key range (LK_R) is found in the first table; and for each obtained physical key (PK), the address translation table is queried to obtain the address corresponding to the physical key (PK), and the value (V) corresponding to the logical key (LK) is read from the address.

According to a fourth aspect of the present application, provided is a first KV storage device according to the fourth aspect of the present application, including a control component and a non-volatile storage medium, wherein the control component executes the first to seventeenth methods for a KV storage device according to the third aspect of the present application.

According to the fifth aspect of the present application, provided is a first method for a KV storage device according to fifth aspect of the present application, including: receiving a key (K) for accessing a KV storage device; acquiring a sorted index for the key (K); acquiring a first hash table from a sorted table according to the sorted index; hashing the key to obtain a hash key (HK); querying the first hash table according to a first part (HK1) of the hash key; and if an entry corresponding to the first part (HK1) of the hash key in the first hash table records a physical address of a value (V) to be accessed by a read operation, reading first data from a storage medium according to the physical address.

According to the first method for a KV storage device according to the fifth aspect of the present application, provided is a second method for a KV storage device according to the fifth aspect of the present application, wherein the sorted index is acquired from a request for accessing the KV storage device, the sorted index is generated from the key (K), or the sorted index is assigned to the key (K).

According to the first or second method for a KV storage device according to the fifth aspect of the present application, provided is a third method for a KV storage device according to the fifth aspect of the present application, further including: to write the value (V) corresponding to the key (K) to the KV storage device, if the sorted index does not exist in the sorted table, adding an entry to the sorted table to record the sorted index and the address of a newly created first hash table, and recording the first part (HK1) of the hash key and the logical address or physical address assigned for recording the value (V) in the newly created first hash table.

According to one of the first to third methods for a KV storage device according to the fifth aspect of the present application, provided is a fourth method for a KV storage device according to the fifth aspect of the present application, further including: in response to instructing the KV storage device to read all values of a key range (K_R), acquiring the sorted index for the key range (K_R); acquiring one or more first hash tables falling within the key range (K_R) from the sorted table according to the sorted index; and for each first hash table, acquiring each entry of the first hash table, and if the entry records the physical address of a value (V) to be accessed, reading the first data from the storage medium according to the physical address.

According to the fourth method for a KV storage device according to the fifth aspect of the present application, provided is a fifth method for a KV storage device according to the fifth aspect of the present application, wherein for each first hash table, the first hash table is queried according to a first part (HK1) of the hash key (HK) matching the key range (K_R); and if the entry corresponding to the first part (HK1) of the hash key in the first hash table records the physical address corresponding to the value (V) to be accessed by a read operation, the data is read from the storage medium according to the physical address.

According to a sixth aspect of the present application, provided is a first KV storage device according to the sixth aspect of the present application, including a control component and a non-volatile storage medium, wherein the control component executes the first to fifth methods for a KV storage device according to the fifth aspect of the present application.

### BRIEF DESCRIPTION OF THE DRAWINGS

To describe the technical solutions in the embodiments of the present application or in the prior art more clearly, the accompanying drawings required for describing the embodiments or the prior art are briefly introduced below. Apparently, the accompanying drawings in the following description show merely some embodiments recited in the present application, and a person of ordinary skill in the art can also derive other accompanying drawings from these accompanying drawings.

FIG. 1A is a block diagram of a solid-state storage device in related art;

FIG. 1B shows a schematic diagram of an address translation system of a solid-state storage device in the prior art;

FIG. 2A is a schematic diagram of a KV storage device based on a logical key according to an embodiment of the present application;

FIG. 2B is a schematic diagram of a KV storage device based on a logical key according to another embodiment of the present application;

FIG. 2C is a schematic diagram of a KV storage device based on a logical key according to still another embodiment of the present application;

FIG. 3A to FIG. 3E show flowcharts of processing an operation interface command according to an embodiment of the present application;

FIG. 4A is a schematic diagram of a KV storage device according to another embodiment of the present application;

FIG. 4B is a flowchart of accessing the KV storage device shown in FIG. 4A by a host according to an embodiment of the present application;

FIG. 4C is a flowchart of accessing the KV storage device shown in FIG. 4A by a host according to another embodiment of the present application;

FIG. 5 shows a schematic diagram of an address translation system of a KV storage device according to still another embodiment of the present application;

FIG. 6 is a detailed schematic diagram of the address translation system of the KV storage device according to according to the embodiment of FIG. 5;

FIG. 7A to FIG. 7C are flowcharts of responding to the access of a host by the storage device according to the embodiment of FIG. 5 or FIG. 6;

FIG. 8 is a schematic diagram of a file system based on a KV storage device according to an embodiment of the present application;

FIG. 9 shows a schematic diagram of a file system based on a KV storage device according to an embodiment of the present application;

FIG. 10 is a schematic diagram of a file system based on a KV storage device according to another embodiment of the present application;

FIGS. 11A-11H record flowcharts of providing a file system service by a file system based on a KV storage device according to the present application;

FIG. 12 is a schematic diagram of a file system based on a KV storage device according to still another embodiment of the present application;

FIG. 13A is a schematic diagram of a KV storage device based on a logical key according to another embodiment of the present application; and

FIG. 13B is a schematic diagram of a KV storage device based on a logical key according to still another embodiment of the present application.

### DETAILED DESCRIPTION

The technical solutions in the embodiments of the present application are clearly and fully described below with reference to the accompanying drawings in the embodiments of the present application. Apparently, the described embodiments are merely some of the embodiments of the present application, but not all the embodiments. Based on the embodiments of the present application, all other embodiments obtained by a person skilled in the art without involving an inventive effort shall fall within the scope of protection of the present application.

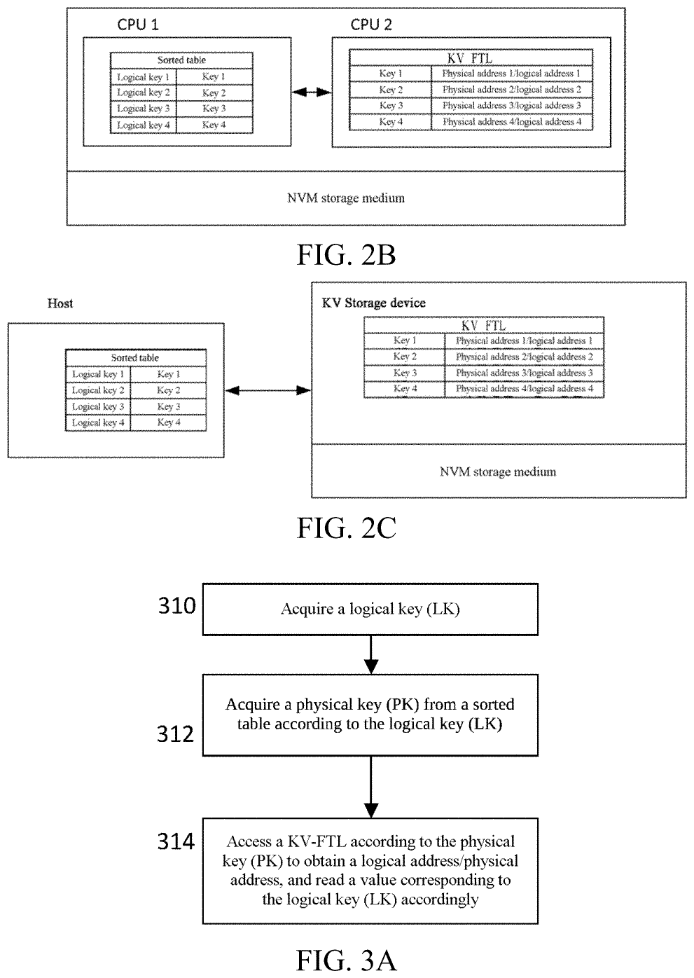

FIG. 2A is a schematic diagram of a KV storage device based on a logical key according to an embodiment of the present application.

According to the storage device in the embodiment of the present application, two types of keys are provided or used to provide more data operation capabilities. The two types of keys used are called logical keys and physical keys, and the latter is also referred to as “keys” for short if there is no confusion. The logical keys correspond one-to-one to the physical keys. As an example, the logical key is, for example, a web page address (such as, www.abc.com/foo.html), a path of a file system (such as, /root/dirl/a.txt), or a logical address in a storage protocol of the prior art (such as, NVMe Protocol). Moreover, the physical key is in the form of a key that is convenient for the storage device to process. For example, the physical key is a Universally Unique Identifier (UUID) having a specified length. Preferably, the physical key has a designated length. As another example, the physical key is the result of hashing the logical key. Still optionally, the physical key is a key used by a KV storage device in the prior art. The Chinese patent application with application No. 201711392 529.2 provides a KV storage device, which is incorporated in the present application in its entirety.

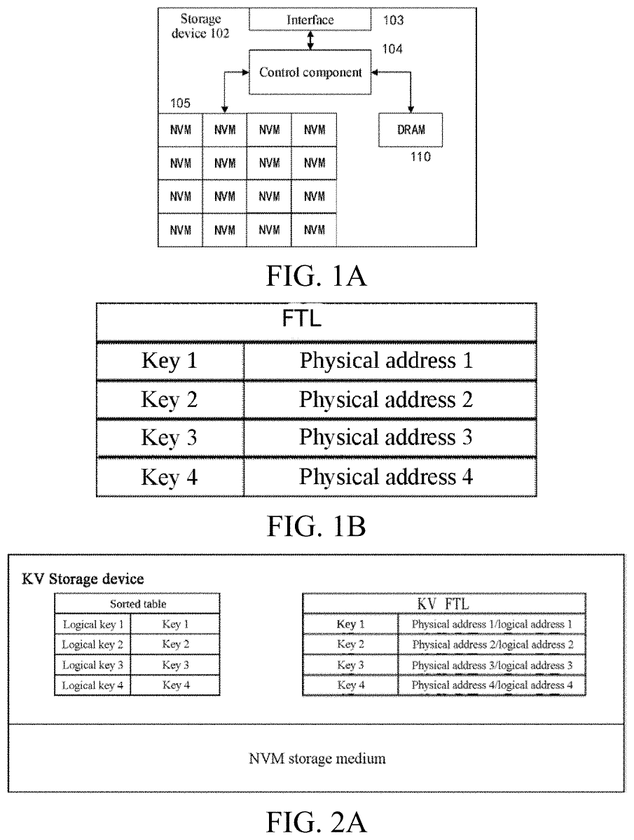

Referring to FIG. 1A and FIG. 2A, the KV storage device according to the embodiments of the present application includes a control component and a memory NVM storage medium. The control component of the KV storage device maintains sorted tables and KV FTLs. Data of the sorted tables and KV FTLs may be stored in the memory or an internal cache of the control component. Optionally, some or all of the sorted tables and/or KV FTLs are stored in the NVM storage medium.

The sorted table records the corresponding relationship between the logical keys and the physical keys (marked as “keys” in FIG. 2A). The sorted table includes multiple entries, and each entry records the corresponding relationship between a pair of logical key and physical key. The multiple entries of the sorted table are sorted according to the logical keys. Therefore, according to the logical key or its prefix part, the corresponding physical key can be queried from the sorted table quickly and efficiently. Moreover, because the entries of the sorted table are sorted according to the logical keys, according to the prefix parts of the logical keys (corresponding to a set of logical keys having the same prefix, the entries corresponding to these logical keys are adjacent in the sorted table), one or more corresponding physical keys can be queried from the sorted table quickly and efficiently. The sorted table may be realized by various data structures such as arrays, link tables, and trees.

The KV FTL records the corresponding relationship between the physical keys (marked as “keys” in FIG. 2) and the logical addresses or physical addresses of the storage device. The storage device can be accessed through the logical address or physical address. The logical address is, for example, the logical address of the storage protocol (such as, the NVMe protocol), and the physical address indicates the physical storage location of an NVM chip. The KV FTL may be realized by various data structures such as arrays, link tables, trees, and hash tables. Optionally, the KV FTL is the FTL of a KV storage device in the prior art.

According to the KV storage device of the embodiment of FIG. 2A, a host coupled with the KV storage device, for example, accesses the KV storage device through a logical key. For example, the read operation (Get (Key)) sent by the host to the KV storage device indicates that the Key to be read is a logical key. The KV storage device receives the logical key, queries the sorted table by using the logical key to obtain the physical key, then queries the KV FTL by using the physical key to obtain the logical address or physical address, and accesses data corresponding to the logical key by using the logical address or physical address. Optionally, the KV storage device of the prior art is used to process the access based on the physical key.

Optionally, according to the KV storage device of the embodiment of the present application, in addition to providing the host with an operation interface similar to the KV storage device in the prior art (for example, read operation (Get (logical key)), write operation (Put (logical key, Value)) and/or delete operation (Delete (logical key))), operations such as accessing the physical key are further provided, for example, reading the physical key (GetKey (logical key), in response to this operation, the KV storage device outputs the physical key corresponding to the logical key recorded in the sorted table).

FIG. 2B is a schematic diagram of a KV storage device based on a logical key according to another embodiment of the present application.

The KV storage device according to the embodiment shown in FIG. 2B includes a control component and a memory NVM storage medium. The control component includes a CPU 1 and a CPU 2. The CPU 1 maintains a sorted table, and the CPU 2 maintains a KV FTL. Taking a read operation (Get (logical key)) as an example, the CPU 1 obtains the physical key corresponding to the logical key from the sorted table according to the logical key, and the CPU 2 obtains a physical address or logical address corresponding to the physical key from the KV FTL according to the physical key.

FIG. 2C is a schematic diagram of a KV storage device based on a logical key according to still another embodiment of the present application.

The operation interface provided by the KV storage device according to the embodiment shown in FIG. 2C to the host is based on physical keys, for example, read operation (Get (physical key)), write operation (Put (physical key, Value)) and/or delete operation (Delete (physical key)). The host coupled with the KV storage device maintains a sorted table for mapping logical keys to physical keys. For example, a driver of the KV storage device running in the host maintains the sorted table. The application program accesses the KV storage device by using the logical key, and the driver of the KV storage device receives the logical key and queries the sorted table to obtain the physical key, and accesses the KV storage device by using the physical key.

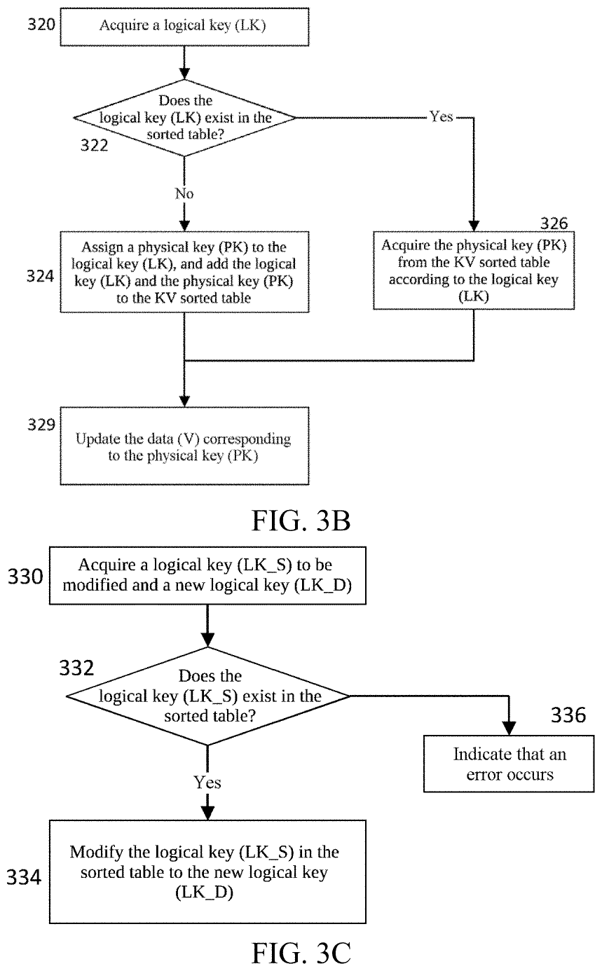

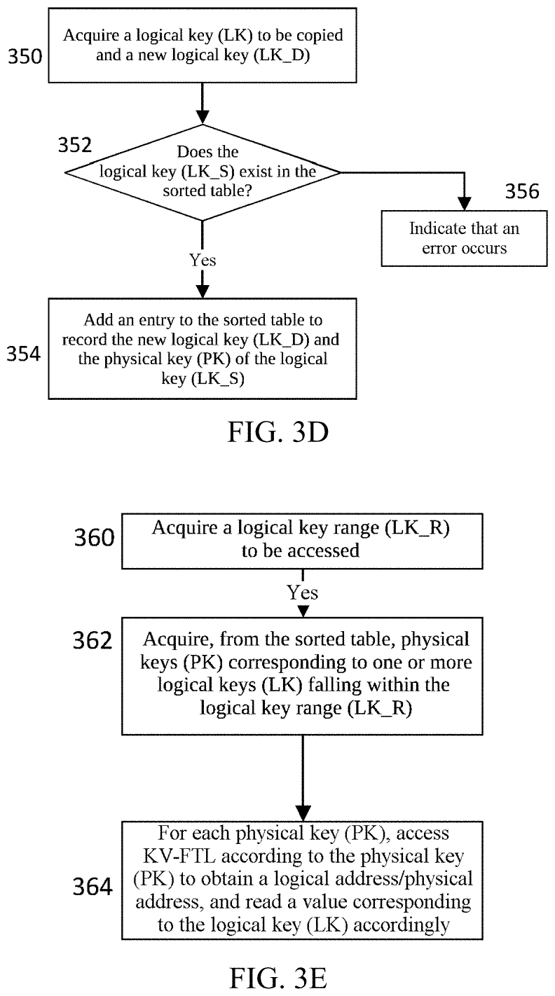

FIG. 3A to FIG. 3E show flowcharts of processing an operation interface command according to an embodiment of the present application.

FIG. 3A is a flowchart of processing a read operation interface command. The read operation interface command (referred to as “read operation”) indicates the logical key (also denoted as LK). The KV storage device receiving the read operation acquires the logical key (LK) from the read operation (310). The KV storage device queries the sorted table according to the logical key (LK) to obtain the physical key (denoted as PK) (312). Moreover, said device accesses the KV FTL according to the physical key (PK) to obtain a logical address or physical address, and reads data from the logical address or physical address as a value corresponding to the logical key (LK) (314).

FIG. 3B is a flowchart of processing a write operation interface command. The write operation interface command (referred to as “write operation”) indicates the logical key (also denoted as LK) and the data (V) to be written. The KV storage device receiving the write operation obtains the logical key (LK) from the write operation (320). The KV storage device queries the sorted table according to the logical key (LK) to identify whether the logical key (LK) exists in the sorted table (322). If the logical key (LK) does not exist in the sorted table (322), a new physical key (PK) is assigned to the logical key (LK), and the logical key (LK) and the newly generated physical key (PK) are added to the sorted table (324). For example, according to a generation rule of the physical key, a hash calculation is performed on the logical key (LK) to generate a physical key (PK); or, a UUID that does not exist in the sorted table is obtained and assigned to the logical key (LK). Moreover, the data (V) corresponding to the newly generated physical key (PK) is updated (329).

If the logical key (LK) already exists in the sorted table (322), the sorted table is queried to obtain the physical key (PK) corresponding to the logical key (LK), and the data (V) corresponding to the queried physical key (PK) is updated (329).

To update the data (V) corresponding to the physical key (PK) (329), for example, to assign a new physical address to the queried physical key (PK), the queried physical key (PK) and the newly assigned physical address are recorded in the KV FTL, and the data (V) is written to the assigned new physical address. Optionally, a new logical address is assigned to the queried physical key (PK), and the value of the assigned new logical address is updated to the data (V) to be written according to the update approach of the storage device in the prior art. Still optionally, according to the update approach of the KV storage device in the prior art, the corresponding data (V) is written to the newly generated physical key (PK).

FIG. 3C is a flowchart of processing a logical key modifying operation interface command. The logical key modifying operation interface command (referred to as “modification key operation”) instructs to update an unmodified logical key (also denoted as LK_S) to a modified logical key (LK_D). The KV storage device receiving the modification key operation acquires the unmodified logical key (LK_S) and the modified logical key (LK_D) from the modification key operation (330). The KV storage device queries the sorted table according to the unmodified logical key (LK_S) to identify whether the unmodified logical key (LK_S) exists in the sorted table (332). If the unmodified logical key (LK_S) does not exist in the sorted table (332), it indicates that an error occurs (336).

If the unmodified logical key (LK_S) exists in the sorted table (332), the unmodified logical key (LK_S) in the sorted table is updated to the modified logical key (LK_D) (334).

FIG. 3D is a flowchart of processing a copy operation interface command. The copy operation interface command (referred to as “copy operation”) instructs to copy a logical key (also denoted as LK_S) to be coped, so that the data (V) of the logical key (LK_S) to be copied can be accessed using a new logical key (LK_D). The KV storage device receiving the copy operation acquires the logical key (LK_S) to be copied and the new logical key (LK_D) from the copy operation (350). The KV storage device queries the sorted table according to the logical key (LK_S) to be copied to identify whether the logical key (LK_S) to be copied exists in the sorted table (352). If the logical key (LK_S) to be copied does not exist in the sorted table (352), it indicates that an error occurs (356).

If the logical key (LK_S) to be copied exists in the sorted table (352), a physical key (PK) corresponding to the logical key (LK_S) to be copied is acquired from the sorted table; a new sorted table entry is generated, which records the corresponding relationship between the new logical key (LK_D) and the acquired physical key (PK) corresponding to the logical key (LK_S) to be copied; and the newly generated sorted table entry is added to the sorted table (354). Moreover, optionally, the newly generated sorted table entry is added to the sorted table, and the entries in the sorted table are still sorted according to logical keys.

FIG. 3E is a flowchart of processing a range query operation interface command. The range query operation interface command (referred to as “range query operation”) indicates a logical key range (also denoted as LK_R) to be accessed. For example, the logical key range (LK_R) is expressed in the form of a logical key prefix or a logical key with a wildcard. The KV storage device receiving the range query operation acquires the logical key range (LK_R) from the range query operation (360). The KV storage device queries the sorted table according to the logical key range (LK_R) to acquire one or more physical keys (PK) corresponding to one or more logical keys (LK) that fall within the logical key range (LK_R) (362). Moreover, for each acquired physical key (PK), the KV FTL is accessed to obtain a logical address or physical address, and data is read from the logical address or physical address as a value corresponding to the logical key (LK) (364). Optionally, for each physical key (PK), the data (V) corresponding to the physical key (PK) is read according to the reading approach of the KV storage device in the prior art.

In one implementation mode, the processes shown in FIG. 3A to FIG. 3E are implemented according to the storage device according to the embodiments of the present application. In another implementation mode, the host is coupled with the KV storage device, the host maintains the sorted table, and the KV storage device maintains the KVF TL. Therefore, the steps before the acquisition of the physical key in FIGS. 3A to 3E are executed by the host, and the step of accessing a corresponding value according to the physical key is executed by the storage device. For example, step 310 and step 312 of FIG. 3A are executed by the host, and other steps are executed by the KV storage device. Step 320, step 322, step 324, and step 326 in FIG. 3B are executed by the host, and step 329 is executed by the KV storage device. The steps of the processes in FIG. 3C and FIG. 3D are all executed by the host. Step 360 and step 362 in FIG. 3E are executed by the host, and step 364 is executed by the KV storage device.

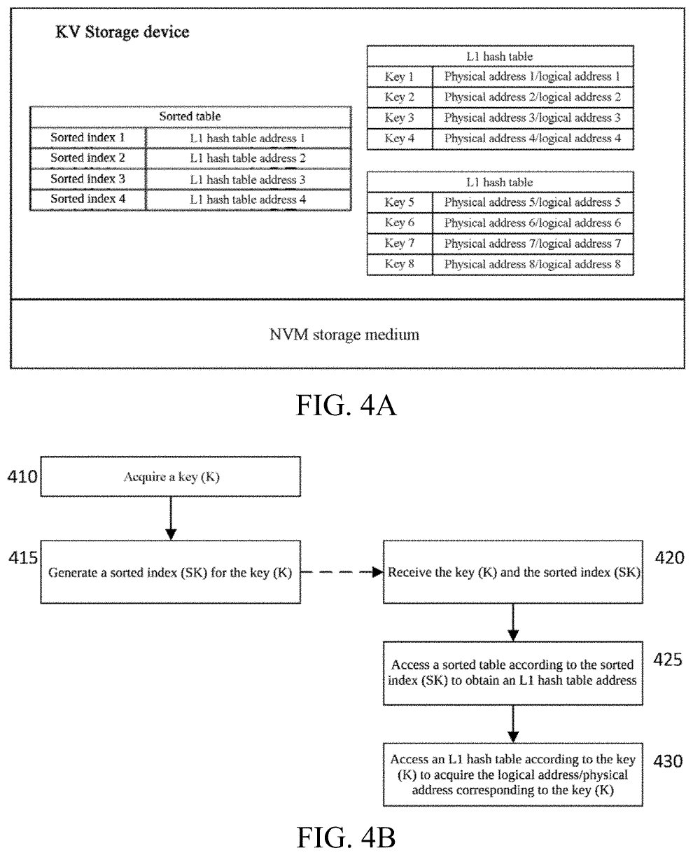

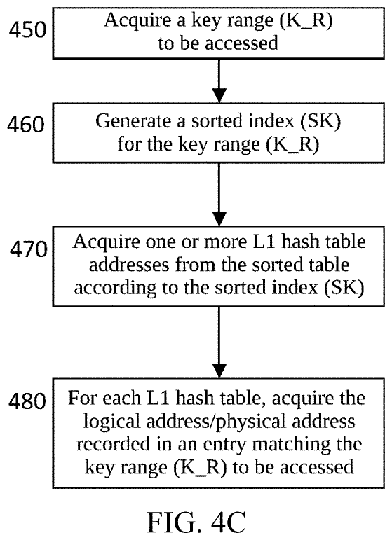

FIG. 4A is a schematic diagram of a KV storage device according to another embodiment of the present application.

Referring to FIG. 4A, the KV storage device according to the embodiment of the present application includes a control component and a memory NVM storage medium. The control component of the KV storage device maintains sorted tables and KV FTLs. The KV FTL includes multiple L1 hash tables. Each L1 hash table is indexed through a key (Key). Entries recorded in the L1 hash table are indexed through keys (Key). The entries of the L1 hash table record, for example, physical addresses or logical addresses of storage units for the data corresponding to storage keys (Key).

The sorted table includes multiple entries, and each entry records the corresponding relationship between the sorted index and a base address of one of the L1 hash tables. The multiple entries of the sorted table are sorted according to the sorted index. Therefore, according to the sorted index or its prefix, the corresponding L1 hash table can be queried from the sorted table quickly and efficiently.

In one implementation mode, the KV storage device according to the embodiment of FIG. 4A indicates keys (Key) and sorted indexes in the operation interface command provided to the host coupled with the KV storage device. The sorted indexes provided by the host are sorted indexes used for the keys in the interface command. The sorted indexes are indexes for the keys (Key) and can be sorted. The sorted indexes have a one-to-one correspondence or a one-to-many relationship with the keys (Key). For example, the keys provided by the host are, for example, UUIDs, and the sorted indexes are numbers or character strings. In another example, the sorted index is a partial prefix of a URL, and the key (Key) is a complete URL.

According to the embodiment of FIG. 4A, to access the KV storage system, the host assigns or generates a sorted index for the key (Key) used. For example, for a key in the form of a file system path, the prefix part of the path is intercepted as the sorted index. In some cases, for a record consisting of <key, data>, the host that generates the record knows its sorted rule, so that the host generates a sorted index for the key (Key) according to the sorted rule of the record, and provides the sorted index to the KV storage device.

FIG. 4B is a flowchart of accessing the KV storage device shown in FIG. 4A by a host according to an embodiment of the present application.

Take a host issuing a read operation interface command (Get (key, sorted index)) to a KV storage device as an example. To read data corresponding to the same key (K), the host acquires the key (K) (410) to be read, generates a sorted index corresponding to the key (K) or acquires the sorted index (SK) corresponding to the same key (K) (415), and issues a read operation interface command to the KV storage device. The key (K) and the sorted index (SK) are indicated in the read operation interface command.

The KV storage device receives the key (K) and the sorted index (SK) (420) in the read operation interface command, queries a sorted table by using the sorted index (SK), and obtains a corresponding L1 hash table according to the obtained L1 hash table address (425). Moreover, the L1 hash table is queried using the key in the read operation interface command to obtain a corresponding logical address or physical address (430), which is used to access the storage device. Data is read from the logical address/or physical address, and is provided to the host as a response to the read operation interface command. Optionally, the L1 hash table is the FTL of a KV storage device in the prior art.

As another example, the host sends a write operation interface command (Put (key, sorted index, data)) to the KV storage device. The host acquires the key (K) to be read, and generates a sorted index for the key (K) or acquires a sorted index corresponding to the key (K). And the host provides the key (K) and the sorted index (SK) to the KV storage device by using the write operation interface command. The KV storage device receives the key and the sorted index in the write operation interface command, queries the sorted table by using the sorted index, and obtains the corresponding L1 hash table according to the obtained L1 hash table address. Moreover, said device queries the L1 hash table by using the key in the write operation interface command to obtain the corresponding logical address or physical address, and writes the data indicated by the write operation interface command thereto. If a record corresponding to the sorted index is not found in the sorted table, or a record corresponding to the key is not found in the L1 hash table, it indicates that the key to be written does not exist in the KV storage device, and the record corresponding to the sorted index is added to the sorted table, and the record corresponding to the key is added to the L1 hash table. Moreover, when needed, a new L1 hash table is also generated.

In another implementation mode, the operation interface command provided by the KV storage device according to the embodiment of FIG. 4A to the host coupled with the KV storage device only indicates a key (Key) but does not indicate a sorted index. The KV storage device generates the sorted index according to the received key. The sorted index is, for example, a sequence number assigned to the key (Key), or a part or prefix of the key (Key).

FIG. 4C is a flowchart of accessing the KV storage device shown in FIG. 4A by a host according to another embodiment of the present application. The host issues a range query operation interface command (referred to as “range query operation”) to the KV storage device. The range query operation indicates the key range (also denoted as K_R) to be accessed (450). For example, the key is a path of file system, and the key range refers to all files in a certain directory, and the key range is in the form of a key prefix or a key with a wildcard. The host also generates a sorted index (SK) according to the key range (460). The key corresponding to the sorted index covers the key range to be accessed. As an example, the sorted table is a prefix tree, and all child nodes of the node of the prefix tree indicated by the generated sorted index (SK) cover all the keys in the key range to be accessed.

The host sends the key range (also denoted as K_R) to be accessed and the sorted index (SK) to the KV storage device. The KV storage device accesses the sorted table according to the sorted index (SK), and obtains addresses of one or more L1 hash tables therefrom (470). For example, according to the node hit by the sorted index (SK), the L1 hash table addresses recorded by all the child nodes of the node in the sorted table are obtained. For each acquired hash table, the logical addresses or physical addresses recorded in all the entries matching the key range (K_R) are acquired therefrom (480), and the logical addresses or physical addresses are accessed, from example, reading data therefrom. In one example, the L1 hash table is traversed to obtain each key therein, and the logical addresses or physical addresses are obtained from the entries matching the same key range (K_R).

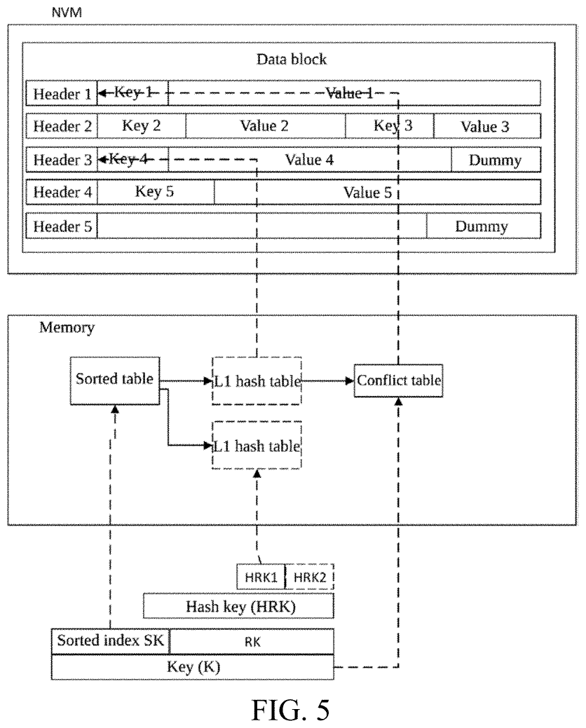

FIG. 5 shows a schematic diagram of an address translation system of a KV storage device according to still another embodiment of the present application.

An NVM chip of the KV storage device (also refer to FIG. 1, NVM chip 105) provides multiple physical blocks. Physical blocks are used as data blocks. The data blocks include physical pages or data frames used to record data written to a solid-state storage device.

Taking physical pages as an example, the data block shown in FIG. 5 includes five physical pages. Each physical page includes a header field (denoted as “header 1”, “header 2” . . . and “header 5”, respectively). Each physical page has a physical address (denoted as PPA), and a corresponding physical page can be accessed using the PPA. The physical page records keys (K) and values (Value), and the keys (Key) and values (Value) are keys (Key) and values (Value) provided by the host when writing data. The physical page further records a header field, and the header field is used for indicating starting addresses and/or lengths of the keys (Key) and/or values (Value).

For example, the physical page indicated by “header 1” in FIG. 5 includes a header field (header 1), key 1 and value 1. The header field records the length of the key (Key) and the length of the value (Value) (while the length of the header field is a fixed value). According to the physical address indicated by the PPA and the length of the header field, the starting address of the key (Key) and the starting address of the value (Value) can be calculated. In one example, the header field records the length of the key (Key), and the starting address of the value (Value) can be calculated according to the physical address indicated by the PPA, the length of the header field, and the length of the key (Key). Moreover, in another example, the starting address of the key (Key) is fixed, and the starting address of the value (Value) of the header field is recorded. In another example, the key (Key) and value (Value) are of a variable length.

Optionally, multiple <key, value> pairs are recorded in the physical page. Take the physical page indicated by “header 2” as an example, wherein “key 2” and “value 2” recorded therein are a pair, and “key 3” and “value 3” are another pair. Moreover, each pair of <key 2, value 2> and <key 3, value 3> is addressed according to “header 2”.

Still optionally, if the sum of the lengths of the header field, key (Key) and value (Value) of a physical page (such as the physical page indicated by “header 3” in FIG. 5) is not enough to fill the physical page, then the physical page is filled with dummy data.

The physical pages indicated by “header 4” and “header 5” are physical pages with consecutive physical addresses, and key 5 and “value 5” are the key (Key) and value (Value) provided by the host when writing data. Because “value 5” exceeds the capacity value of the physical page, the physical page indicated by “header 4” records key 5 and a part of value 5 provided by the host. The remaining part of “value 5” is recorded in the physical page indicated by “header 5”. “Header 4” and “header 5” of the header field are used to indicate the starting addresses and/or lengths of “key 5” and “value 5” in the physical page. Optionally, the number of physical pages occupied (the number is 2) is also recorded in the header field.

Optionally, still referring to the physical pages indicated by “header 4” and “header 5” in FIG. 5, and the size of the header field and the key (Key) and value (Value) are not enough to fill the two physical pages, and the physical page indicated by “header 5” is filled with dummy data.

Continuing to refer to FIG. 5, the key (K) provided by the host or user includes or is divided into two parts, i.e., a sorted index (SK) and RK. The sorted index (SK) and RK are combined to obtain the key (K). Hash calculation is performed on RK to obtain a hash key (denoted as HRK). Optionally, the hash key (HRK) has a designated length. Still optionally, the hash key (HRK) is divided into multiple parts. For example, the hash key (HK) is divided into two parts, denoted as HRK1 and HRK2. For example, for a hash key (HRK) with a length of 128 bits, HRK1 is the first 64 bits of the hash key (HRK), and HRK2 is the next 64 bits of the hash key (HRK). Understandably, there are lots of other ways to divide the hash key (HRK) into multiple parts without limiting the way of selecting the bits of the hash key (HRK), and the order and/or length thereof, etc.

In an alternative implementation mode, the key (K) provided by the host or the user is taken as RK, and a sorted index (SK) corresponding to RK is additionally obtained or generated. For example, a part of RK is intercepted as the sorted index (SK). In this implementation mode, RK is the same as the key (K).

Still referring to FIG. 5, a memory of the storage device (also referring to FIG. 1, for example, DRAM 110) records various data tables, including sorted tables, L1 hash tables, and conflict link tables.

The sorted table includes multiple entries, and each entry records the corresponding relationship between the sorted index (SK) and the base address of one of the L1 hash tables. The multiple entries of the sorted table are sorted according to the sorted index. Therefore, according to the sorted index or its prefix, the corresponding L1 hash table can be queried from the sorted table quickly and efficiently.

One or more L1 hash tables are provided. The L1 hash table is indexed by a part HRK1 of the hash key (HRK). For example, entries of the L1 hash table are obtained by taking HRK1 as an offset value in the L1 hash table. The entries of the L1 hash table record the logical addresses/physical addresses of the data blocks or the addresses of a conflict table.

One or more conflict tables are provided. The entries of the L1 hash table record the addresses of the conflict tables, so that the conflict tables can be addressed according to the entries of the L1 hash table. (Each) conflict table is indexed by a key (K). The entries of the conflict table record the physical page (or data unit) addresses of the data blocks.

In an alternative implementation mode, one or more L2 hash tables are provided. The entries of the L1 hash table optionally record the addresses of the L2 hash table, so that the L2 hash table can be addressed according to the entries of the L1 hash table. (Each) L2 hash table is indexed by a part HRK2 of the hash key (HRK). For example, entries of the L2 hash table are obtained by taking HRK2 as an offset value in the L2 hash table. The entries of the L2 hash table record the physical addresses/logical addresses of the data blocks or the addresses of the conflict table.

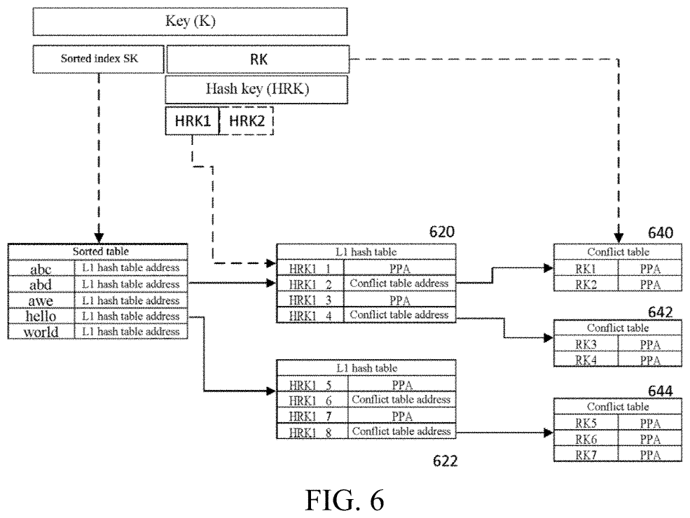

FIG. 6 is a detailed schematic diagram of the address translation system of the KV storage device according to according to the embodiment of FIG. 5.

Each entry of the conflict table is indexed by a sorted index (SK), and the value of the entry is the address of the L1 hash table. As an example, the sorted index (SK) is used as an index to access the sorted table, to obtain a sorted table entry that matches the sorted index (SK). Referring to FIG. 6, if the sorted index (SK) is a character string “hello”, it matched with the fourth entry of the sorted table in FIG. 6, and this entry records, for example, the address of the L1 hash table 622.

A designed hash calculation is performed on RK to obtain a hash key (HRK). Each entry of the L1 hash table is indexed by a part (HRK1) of the hash key (HRK), and the value of the entry is the logical address/physical address of the data block or the conflict table address. As an example, the entry of the L1 hash table is accessed by taking HRK1 as the address or offset value. If the entry of the L1 hash table records the physical address/logical address of the data block, the address indicates the storage location of a <key (K), data (V)> pair in an NVM storage medium.

Understandably, the index HRK1 of the L1 hash table is different from the hash key (HRK). Moreover, HRK1 is not in a one-to-one correspondence to the hash key (HRK), but multiple hash keys (HRK) can all correspond to the same HRK1. Therefore, according to the <key (K), data (V)> accessed by HRK1 from the physical address/logical address of the data block indexed by the L1 hash table, there is a certain probability that it does not correspond to the RK that is accessed by the host/user and is used to generate the hash key (HRK), resulting in the occurrence of an error. In some cases, the probability of occurrence of such an error is extremely small, and this error can be accepted by the technical standards followed by users or solid-state storage devices. In other cases, this error cannot be accepted, and it is also necessary to compare whether the key (K) accessed from the physical address/logical address of the data block indexed by the L1 hash table is the same as the combination of the RK to be accessed by the user and the sorted index (SK) to identify whether the error has occurred.

If the entry of the L1 hash table records a conflict table address, the address indicates the location of one of the conflict tables associated with the entry in a memory. Therefore, the entry of the conflict table is also associated with HRK1.

For example, referring to FIG. 6, in the L1 hash table 620, the entry indexed by HRK1-1 records the physical address PPA, the entry indexed by HRK1-2 records the address of the conflict table 640, and the entry indexed by HRK1-4 records the address of the conflict table 642. In the hash table 622, the entry indexed by HRK1-8 records the address of the conflict table 644.

Each entry of the conflict table is indexed by RK, and the value of the entry is the physical address/logical address of the data block. FIG. 6 shows the conflict table 640, the conflict table 642, and the conflict table 644. The conflict tables are, for example, arrays, link tables, linear tables, or trees. Optionally, the conflict table is sorted, for example, sorted according to the value of RK, so as to support quick search of entries indexed by RK in the conflict table through RK.

According to the embodiment shown in FIG. 3, each entry of the L1 hash table is associated with a sorted index (SK) and HRK1. Moreover, multiple RKs may all correspond to the combination of the same sorted index (SK) and HRK1. For example, both RK1 and RK2 correspond to the combination of the same sorted index (SK) and HRK1, so that the sorted index (SK) and HRK1-2 obtained according to the key (K1) are associated with the entries of the L1 hash table 620 indicated by HRK1-2, and the sorted index (SK) and HRK1-2 obtained according to the key (K2) are also associated with the entries of the L1 hash table indicated by HRK1-2. In this case, the entries of the L1 hash table indicated by HRK1-2 conflict. To resolve the conflict, a conflict table 640 is created to record the association relationship between the key (K1) or RK1 and the physical address/logical address thereof, and also to record the association relationship between the key (K2) or RK2 and the physical address/logical address thereof. In addition, the address of the conflict table 640 is recorded in the entry of the L1 hash table indicated by HRK1_2.

Optionally, the L1 hash table has a designated size (for example, 1 KB-4 MB), and the number of entries in the conflict table is not limited. Still optionally, the sizes of the L1 hash table and the conflict table are selected to make the tables easy to be accessed by an operating system or a Memory Management Unit (MMU), and/or easy to be stored in an NVM storage medium.

In a still alternative implementation mode, the solid-state storage device includes multiple address translation systems as shown in FIG. 6. Moreover, each name space of the solid-state storage device corresponds to one of the address translation systems shown in FIG. 6.

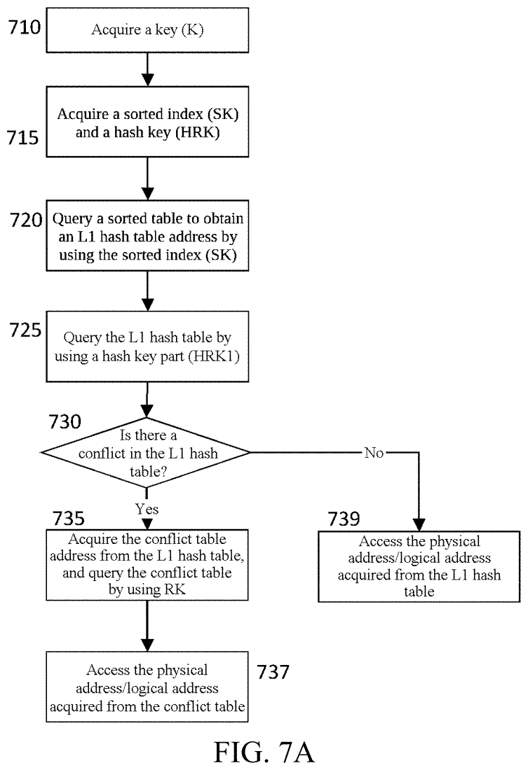

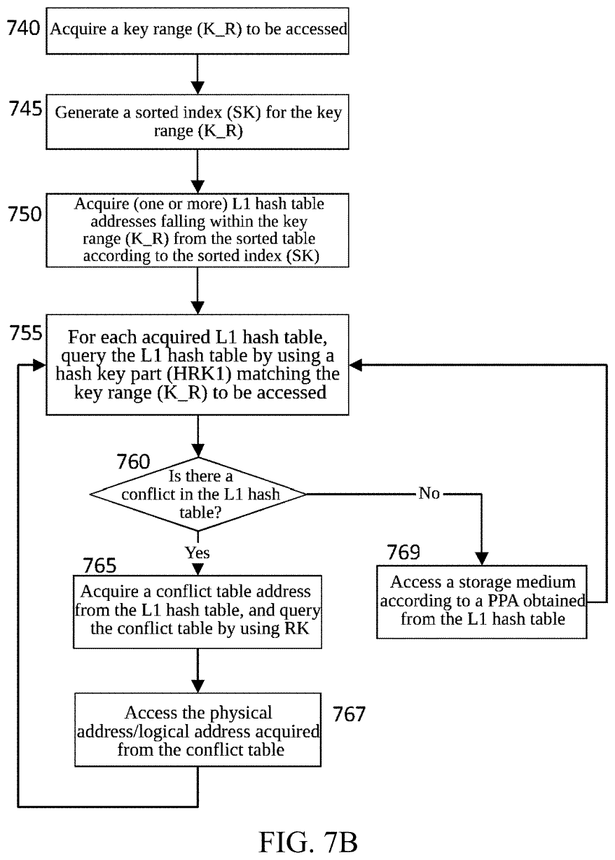

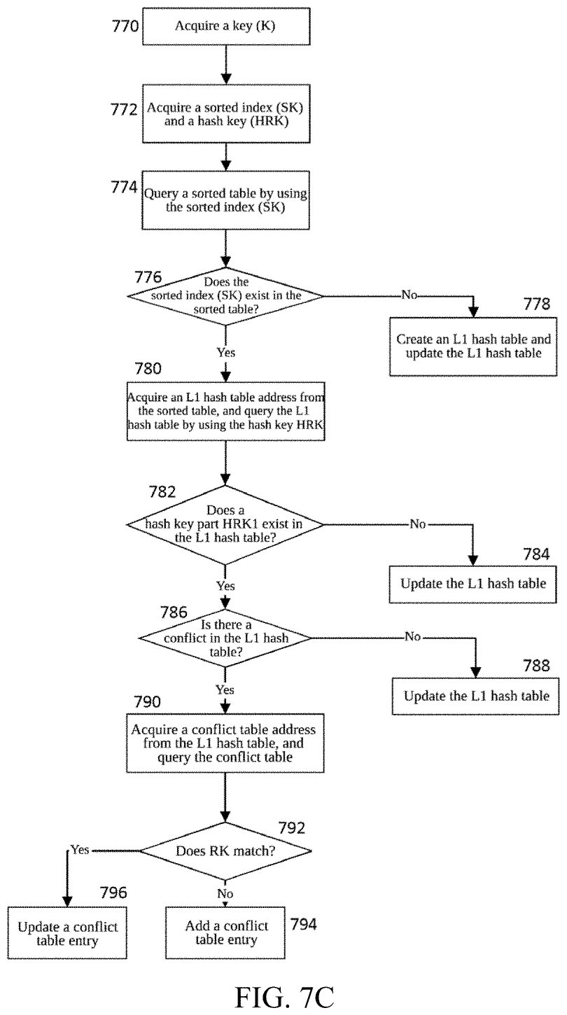

FIG. 7A to FIG. 7C are flowcharts of responding to the access of a host by the storage device according to the embodiment of FIG. 5 or FIG. 6.

According to FIG. 7A, the storage device responds to the read operation interface command (Get (K)) issued by the host. To read the data corresponding to the same key (K), the storage device acquires a key (K) from a read operation (710), generates a sorted index (SK) and RK according to the key (K), and performs a designated hash calculation on RK to obtain a hash key (HSK) (715). For example, the front part of the key (K) having a designated length is taken as the sorted index (S K), and the other part of the key (K) is taken as RK.

The sort index (SK) is used to query the sort table, to obtain a corresponding L1 hash table according to the obtained L1 hash table address. (720) Moreover, a part HRK1 of the hash key (HRK) obtained from a read operation interface command is used to query the L1 hash table (725). If there is no entry corresponding to the hash key part HRK1 in the L1 hash table, it indicates that the key (K) corresponding to the read operation interface command does not exist.

The L1 hash table entry obtained using HRK1 is accessed. If the L1 hash table entry indicates that there is no conflict (730), then the logical address or physical address is recorded in the L1 hash table entry, the logical address or physical address is accessed (739), and the read data is regarded as the data corresponding to the same key (K). Optionally, the key (Kp) is also acquired from the read data, and it is compared whether the key (Kp) is the same as the key (K). If the key (Kp) is the same as the key (K), the value stored in association with the key (Kp) in the NVM storage medium is the value corresponding to the same key (K), and the value is taken as the result of the read operation. If the key (Kp) is different from the key (K), then the value stored in association with the key (Kp) in the NVM storage medium is not the value corresponding to the same key (K), thus it indicates that the value corresponding to the same key (K) does not exist in the solid-state storage device.

If the L1 hash table entry obtained by HRK1 indicates that there is a conflict (730), what is recorded in the L1 hash table entry is the address of the conflict table, the conflict table is acquired using this address, and the conflict table is inquired using RK (735) to obtain the conflict table entry. The logical address or physical address is recorded in the conflict table entry, the logical address or physical address is accessed (737), and the read data is regarded as the data corresponding to the same key (K). Optionally, the key (Kp) is also acquired from the read data, and it is compared whether the key (Kp) is the same as the key (K). If the key (Kp) is the same as the key (K), the value stored in association with the key (Kp) in the NVM storage medium is the value corresponding to the same key (K), and the value is taken as the result of the read operation. If the key (Kp) is different from the key (K), then the value stored in association with the key (Kp) in the NVM storage medium is not the value corresponding to the same key (K), thus it indicates that the value corresponding to the same key (K) does not exist in the solid-state storage device.

In an alternative implementation model, the index of the conflict table is the key (K), and in step 735, the conflict table is queried using the key (K).

According to FIG. 7B, the storage device responds to the range query operation interface command issued by the host (referred to as “range query operation”). The range query operation indicates the key range (also denoted as K_R) to be accessed (740). The storage device generates a sorted index (SK) according to the key range (K_R) (745). The key corresponding to the sort index (SK) covers a key range (K_R) to be accessed. As an example, the sorted table is a prefix tree, and all child nodes of the node of the prefix tree indicated by the generated sorted index (SK) cover all the keys in the key range (K_R) to be accessed. As another example, a single item (for example, a leaf node of a sorted tree) is queried from the sorted table through the sorted index (SK), and the L1 hash table recorded by this entry covers all the keys in the key range (K_R) to be accessed.

The sorted table is accessed according to the sorted index (SK) to obtain addresses of one or more L1 hash tables therefrom (750). For example, according to the node hit by the sorted index (SK), the L1 hash table addresses recorded by all the child nodes of the node in the sorted table are obtained. For each acquired L1 hash table, the hash key part HSK1 corresponding to all keys (K) matching the same key range (K_R) is used to access the L1 hash table (755) to obtain a hash table entry.

For each entry obtained from each L1 hash table, it is identified whether there is a conflict (760). If the L1 hash table entry indicates that there is no conflict (760), the logical address or physical address is recorded in the L1 hash table entry, the logical address or physical address is accessed (769), and the read data is taken as the same key (K). If the L1 hash table entry indicates that there is a conflict (760), the address of the conflict table is recorded in the L1 hash table entry, a conflict table is acquired using the address, RK corresponding to the hash key part HRK1 that hits the entry of the L1 hash table is used to the conflict table (765) to obtain the conflict table entry. The logical address or physical address is recorded in the conflict table entry, the logical address or physical address is accessed (737), and the read data is regarded as the data corresponding to the same key (K).

In one example, as an alternative to step 755, each L1 hash table is traversed to obtain a part key HRK1 recorded by each entry therein, and the logical address or physical address is acquired from the entry where the component key HRK1 that matches the key range (K_R) is located. If the entries of the L1 hash table conflict, the logical address/physical address is obtained from all the entries recorded in the corresponding conflict table, and the data is read.

In another example, as an alternative to step 755, each L1 hash table is traversed to acquire all the entries therein, and physical addresses/logical addresses or the physical addresses/logical addresses in all the entries of the conflict table corresponding thereto are acquired from each L1 hash table entry. Moreover, data is acquired from the physical address/logical address as a response to the range query operation interface command.

According to FIG. 7C, the storage device responds to a write operation interface command (Put (K, V)) sent by a host. To write data to a key (K), the storage device obtains the key (K) from a write operation (770), generates a sorted index (SK) and RK according to the key (K), and performs designated hash calculation on RK to obtain a hash Key (HSK) (772). For example, the front part of the key (K) having a designated length is taken as the sorted index (SK), and the other part of the key (K) is taken as RK.

The sorted index (SK) is used to query a sorted table (774). If there is no entry in the sorted table that matches the sorted index (SK) (776), a new L1 hash table is created, a new entry that matches the sorted index (SK) is added to the sorted table, and a base address of the newly created L1 hash table is recorded in a new sort table entry. Moreover, a physical address/logical address is assigned for the data to be written, and a record is added to the newly created L1 hash table. The added record is indexed by a part HSK1 of the hash key (HSK), and takes the assigned physical address/logical address as a value (778). The data corresponding to the write operation interface command is also written to the assigned physical address/logical address.

If the sorted index (SK) matches the entry of the sorted table (776), the base address of the L1 hash table is acquired from the matched entry, and the hash key part HRK1 is used to query the L1 hash table (780).

If there is no entry corresponding to the hash key part HRK1 in the L1 hash table (782), it indicates that the key (K) corresponding to the write operation interface command does not exist. The L1 hash table is updated (784), an entry is added to the L1 hash table, the added entry is indexed by the hash key part HRK1, and the assigned physical address/logical address is recorded in the entry. Moreover, data is written to the newly assigned physical address/logical address.

If a partial key HRK1 exists in the L1 hash table (782), whether the partial key HRK1 conflicts in the L1 hash table is further identified (786). If there is no conflict, the data is written to the newly assigned physical address/logical address; the address recorded in the L1 hash table entry indexed by the partial key HRK1 is updated to the newly assigned physical address/logical address (788); and if the partial key HRK1 has a conflict in the L1 hash table (786), the address of the conflict table is acquired according to the L1 hash table entry indexed by the partial key HRK1, and the conflict table is queried using RK (790). If an entry indexed by RK is found in the conflict table (792), the entry is updated with the assigned physical address/logical address (796). If the entry indexed by RK does not exist in the conflict table (792), an entry that is indexed by RK and uses the assigned physical address/logical address as a value is added to the conflict table (794).

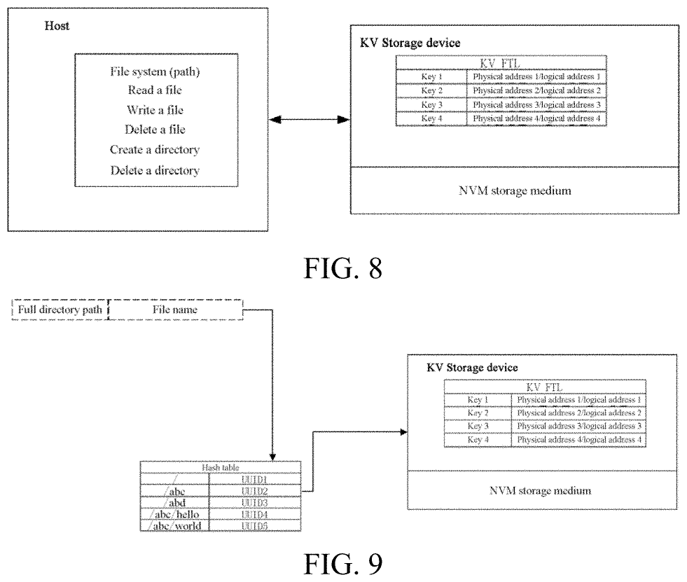

FIG. 8 is a schematic diagram of a file system based on a KV storage device according to an embodiment of the present application.

A host is coupled with a KV storage device. The KV storage device provides a key (K)-based access interface to the host. The KV storage device is, for example, a KV storage device in the prior art, or a KV storage device according to an embodiment of the present application. The host includes a file system configured to use the KV storage device and provide a file system service to a user or an application.

The file system uses a file system path to describe a file or a directory. Moreover, file system services such as reading a file, writing a file, deleting a file, creating a directory, deleting a directory, and modifying a path are provided. The file system provides file system interfaces. The file system interfaces include, for example, a read file interface, a write file interface, a create file interface, a delete file interface, a file rename interface, a create directory interface, a delete directory interface, directory rename interface, a copy file or directory interface, a create file or directory link interface, and the like. The file system is accessed through the file system interface.

Optionally, the file system is provided by the KV storage device. For example, a program that implements the file system is run on a CPU of the KV storage device, and a file system interface is provided to the host coupled to the KV storage device.

FIG. 9 shows a schematic diagram of a file system based on a KV storage device according to an embodiment of the present application.

Taking the file system path of the file as an example, said path includes a full path and file name of a directory where the file is located. The full path and file name of the directory where the file is located are stitched to obtain the file system path for the file. For the directory, the file system path thereof is the full path of the directory. Both the directory and the file are objects of the file system. The file system includes a unique root directory.

For example, the root directory is denoted as “/”, the file system path of the directory starts with the root directory and includes the path of parent directories at all levels of the directory. The directory with the file system path being “/abc” is a subdirectory of a root directory “/”. The directory with the file system path being “/abc/hello” is a subdirectory of the subdirectory “abc” of the root directory “/”.

According to the embodiment of FIG. 9, the file system path and a corresponding key are recorded in the entry of the sorted table. The file system path is used as a sorted index of the entry, and the corresponding key is the value of the entry. For example, the key is a UUID generated for the file system path. The sorted table records the entries corresponding to each directory and file managed by the file system. Optionally, two or more entries are allowed to record the same UUID in the sorted table, so as to provide functions such as linking and copying for the file system.

As an example, the sorted table is provided by the host as a part of the file system. The file system uses the file system path to query the sorted table, to obtain the key (or UUID) corresponding to the file system path, and uses the key to access the KV storage device.

A value (V) corresponding to the key (K) is recorded in the KV storage device. For the key obtained through the file system path of the file, the value thereof is the content of the file. Optionally, the value also includes attribute information of the file. Still optionally, for the key (K) obtained through the file system path of the file, two or more keys (such as, K and K−1) are generated. In the KV storage device, the value corresponding to the file is obtained through the key (K), and the attribute information corresponding to the same file is obtained through the key (K−1). For the key obtained through the file system path of the directory, the value recorded in the KV storage device is the content of the directory, including, for example, attribute information including file names or directory names of all files and subdirectories in a directory that is this directory.

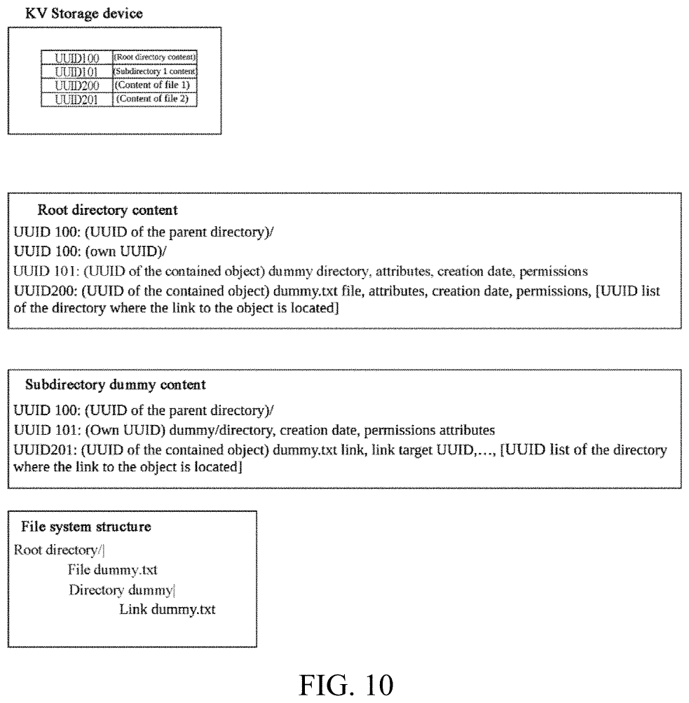

FIG. 10 is a schematic diagram of a file system based on a KV storage device according to another embodiment of the present application.

The KV storage device records the key (K) and the corresponding value (V). The key is, for example, UUID, and the value is file content or directory content. For example, the value corresponding to the key UUID100 is the content of the root directory, the value corresponding to the key UUID 101 is the content of subdirectory 1, the value corresponding to UUID200 is the content of file 1, and the value corresponding to the key UUID201 is the content of file 2.

FIG. 10 also shows an exemplary file system structure. The root directory of the file system is “I”, which includes a subdirectory “dummy” and a file “dummy.txt”. The subdirectory “dummy” further includes a link to the file “dummy.txt” in the root directory.

FIG. 10 also shows the content of the root directory and the content of the subdirectory “dummy”.

The content of the root directory is the value corresponding to the key UUID100 recorded in the KV storage device. The content of the root directory includes multiple records, and each record describes the attribute information including file names or directory names of all files and subdirectories in a directory that is the root directory. The content of the root directory in FIG. 10 includes four records. The first record (line 1) indicates the UUID (UUID 100) of the parent directory of the directory (root directory); and the second record (line 2) indicates its own UUID (UUID100) of this directory (root directory). Optionally, the second record further records information such as the name, type, and attributes of the root directory itself. Because the “root directory” has no parent directory, its own UUID of the root directory is also recorded in the first record. In the root directory content in FIG. 10, the third record (line 3) indicates the UUID (UUID 101) of the object contained in the root directory, and also indicates the name of the object (“dummy”); the type of the object is “directory”, the relevant attributes, creation date, permissions, etc. of the object. In the root directory content in FIG. 10, the fourth record (line 4) indicates the UUID (UUID 200) of the object contained in the root directory, and also indicates the name of the object (“dummy.txt”); the type of the object is “file”, the relevant attributes, creation date, permissions, etc. of the object. Optionally, the fourth record (line 4) further records the UUIDs (UUID list) of the directories where one or more links to the object in the file system are located.

Understandably, for each subdirectory and each file contained in the root directory, a corresponding record is provided in the content of the root directory. The content of the directory “dummy” is the value corresponding to the key UUID 101 recorded in the KV storage device. The content of the root directory includes multiple records, and each record describes the attribute information including file names or directory names of all files and subdirectories in a directory that is this subdirectory. The content of the subdirectory “dummy” in FIG. 10 includes three records. The first record (line 1) indicates the UUID of the parent directory (UUID 100, i.e., the UUID of the root directory) of the subdirectory (subdirectory “dummy”). The second record (line 2) indicates its own UUID (UUID 101) of the subdirectory (subdirectory “dummy”), and also indicates its own name (“dummy”). Its own type is “directory”, own related attributes, creation date, permissions, etc. In the content of the subdirectory “dummy” in FIG. 10, the third record (line 3) indicates the UUID (UUID 201) of the object contained in the directory, and also indicates the name of the object (“dummy.txt”). The type of the object is “link”, the UUID of the target of the link (that is, the UUID of the file “dummy.txt” in the root directory), and related attributes, creation date, permissions, etc. of the object. Optionally, the third record (line 3) further records the UUIDs (UUID list) of the directories where one or more links to the object in the file system are located.

Understandably, for each subdirectory and each file contained in the subdirectory “dummy”, a corresponding record is provided in the content of the subdirectory.

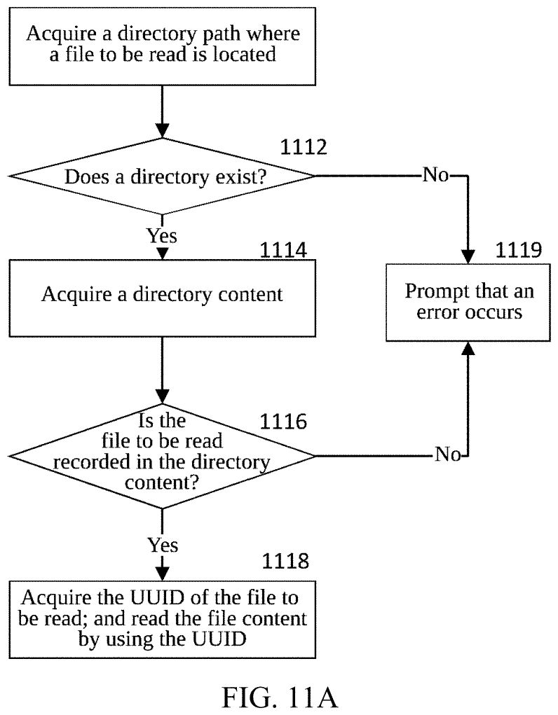

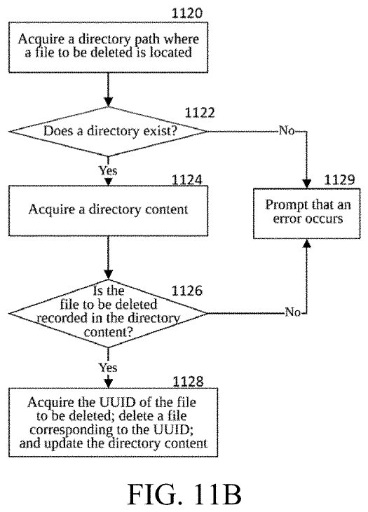

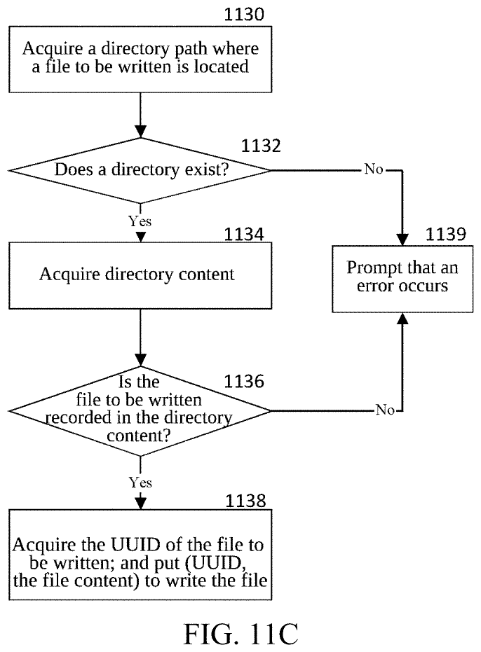

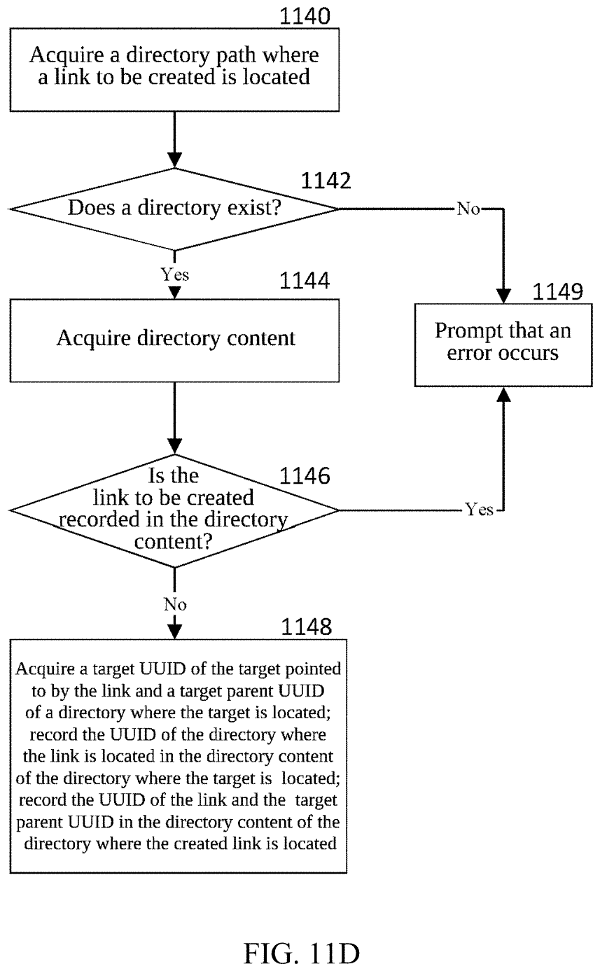

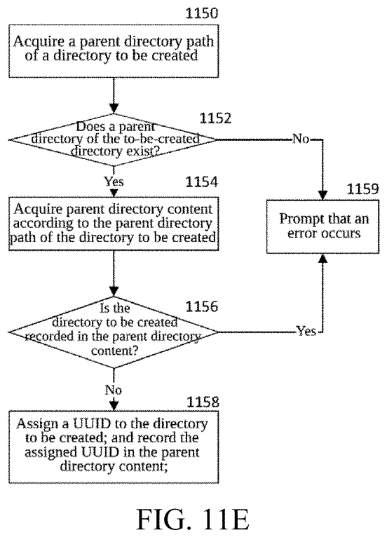

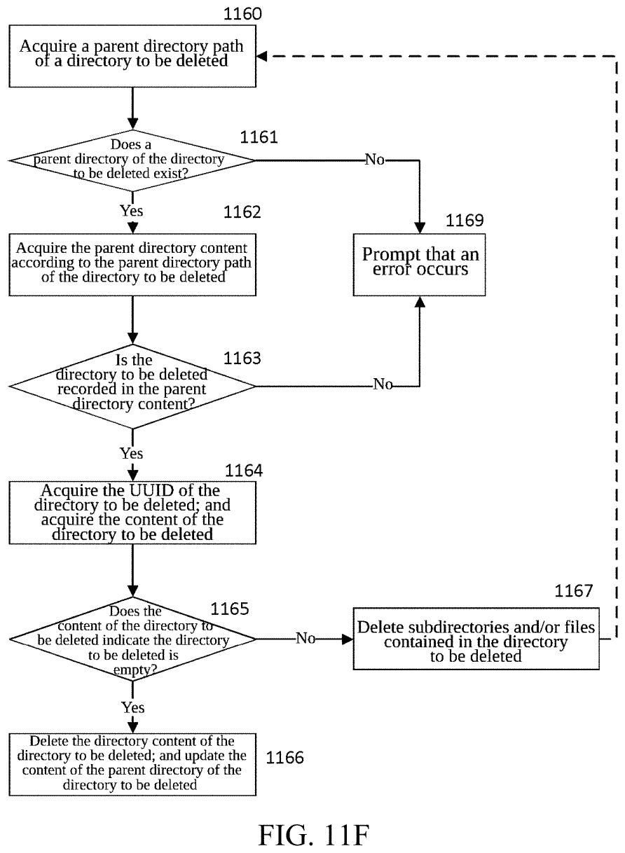

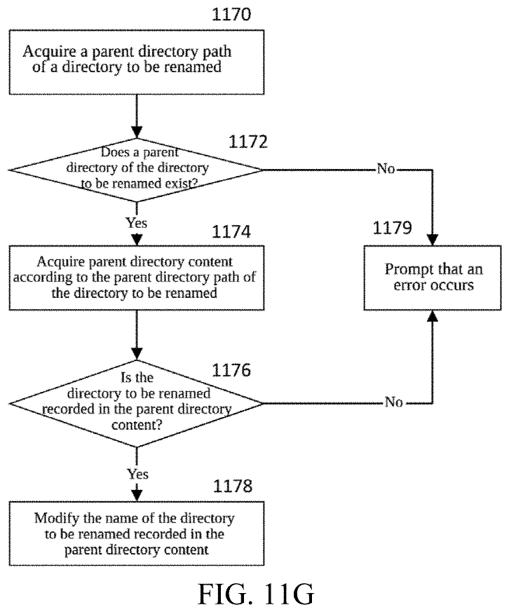

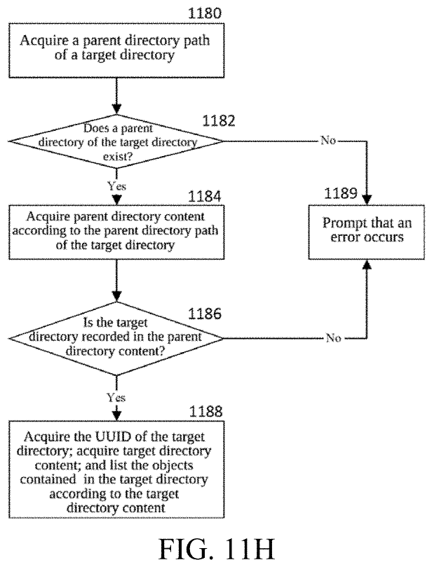

FIGS. 11A-11H record flowcharts of providing a file system service by a file system based on a KV storage device according to the present application. FIG. 11A shows the process of providing a file reading service by a file system. To read a file, a file system path of the file to be read is provided to the file system, including the directory where the file is located and the file name (1110). The file system acquires the directory where the file is located from the received file system path, and identifies whether the directory exists (1112). The file system uses the parent directory content of the directory, and searches for records matching the directory name from the parent directory content to identify whether the directory exists. Moreover, starting from the root directory, whether the parent directories of the directory to be accessed exist is identified by searching for the parent directories of the directory where the file is located step by step, acquires UUIDs of the parent directories, obtains the UUIDs of the parent directories of the directory to be accessed through the UUIDs of the parent directories at all levels, and acquires the directory content of the parent directories of the directory to be accessed. The UUID of the root directory is, for example, known.

In step 1112, if the directory does not exist, the file system indicates to the user or the application that an error occurs (1119) because the directory to be accessed does not exist. If the directory exists, the UUID of the directory is obtained, and the UUID is used to access the KV storage device to obtain the directory content (1114). The file name of a file to be read is used to search for records in the directory content obtained in step 1114 to identify whether a record associated with the file name of the file to be read is recorded in the directory content (1116). If the file to be read is not found in step 1116, it is indicated to the user or the file system that the file to be read does not exist (1119). If the record corresponding to the file to be read is found in step 1116, the UUID of the file to be read is obtained from the records, and the UUID is used to read the KV storage device, so as to read the content of the file to be read (1118).

FIG. 11B shows the process of providing a file deleting service by a file system. To delete a file, a file system path of the file to be deleted is provided to the file system, including the directory where the file is located and the file name (1120). The file system acquires the directory where the file is located from the received file system path, and identifies whether the directory exists (1122). In step 1122, if the directory does not exist, the file system indicates to the user or the application that an error occurs (1129) because the file to be deleted does not exist. In step 1122, if the directory exists, the UUID of the directory is obtained, and the UUID is used to access the KV storage device to obtain the directory content (1124). The file name of a file to be deleted is used to search for records in the directory content obtained in step 1124 to identify whether a record associated with the file name of the file to be deleted is recorded in the directory content (1126). If the file to be deleted is not found in step 1126, it is indicated to the user or the file system that the file to be deleted does not exist (1129). If the record corresponding to the file to be deleted is found in step 1126, the UUID of the file to be deleted is obtained from the record, and the UUID is used to access the KV storage device to delete the value corresponding to the UUID; and the UUID of the directory where the file to be deleted is also used to access the KV storage device to update the directory content of the directory where the file to be deleted is located, and delete the record corresponding to the file to be deleted in the file content (1128).

FIG. 11C shows the process of providing a file writing service by a file system. To write a file, a file system path of the file to be written is provided to the file system, including the directory where the file is located and the file name (1130). The file system acquires the directory where the file is located from the received file system path, and identifies whether the directory exists (1132). In step 1132, if the directory does not exist, the file system indicates to the user or the application that an error occurs (1139) because the file to be written does not exist. In step 1132, if the directory exists, the UUID of the directory is obtained, and the UUID is used to access the KV storage device to obtain the directory content (1134). The file name of a file to be written is used to search for records in the directory content obtained in step 1134 to identify whether a record associated with the file name of the file to be written is recorded in the directory content (1136). If a file to be written is not found in step 1136, it is indicated to the user or the file system that the file to be written does not exist (1139). If a record corresponding to the file to be written is found in step 1136, the UUID of the file to be written is obtained from the record, and the UUID is used to access the KV storage device to update the value corresponding to the UUID (1138). Optionally, the UUID of the directory where the file to be written is also used to access the KV storage device, to update the directory content of the directory where the file to be written is located, and the attribute information of the record corresponding to the file to be written, for example, the last time the file was updated, is updated in the file content.

A file modification service provided by the file system is processed in a similar process as shown in FIG. 11C. In step 1138, the UUID of the file to be modified is used to read the file to be modified from the KV storage device, and the modified file is written into the KV storage device with the same UUID. Alternatively, the UUID of the file to be modified, the modified location and the modified value of the file to be modified are indicated to the KV storage device.

A file creation service provided by the file system is processed in a similar process as shown in FIG. 11C. In step 1136, if a file to be created is found in step 1136, an error is indicated to the user or the file system (the file to be created already exists). If the file to be created is not found in step 1136, a record is added to the directory content of the directory where the file to be created is located to indicate the UUID, file name, attribute information, etc. assigned to the file to be created. Optionally, there is no need to use the UUID of the file to be created to access the KV storage device, because no content has been written into the file to be created.

FIG. 11D shows the process of providing a link creation service by a file system. A link to be created has a file system path thereof, and the file system path of the directory or file of the file system to which the link points (referred to as a target file system path). To create a file, a file system path of the link to be created is provided to the file system, including the directory where the link is located and the file name (1140). The file system acquires the directory where the link is located from the received file system path, and identifies whether the directory exists (1142). In step 1142, if the directory does not exist, the file system indicates to the user or application that an error occurs (1149). In step 1142, if the directory exists, the UUID of the directory is obtained, and the UUID is used to access the KV storage device to obtain the directory content (1144). The name of the link to be created is used to search for records in the directory content obtained in step 1144 to identify whether a record associated with the name of the link to be created is recorded in the directory content (1146). If the link to be created is found in step 1146, an error is indicated to the user or the file system (the link to be created already exists). If the link to be created is not found in step 1146, the UUID assigned to the link to be created, the UUID of the target pointed to by the link to be created (called the target UUID) and the UUID of the target directory (called the target parent UUID) are acquired, the record corresponding to the target UUID is updated in the directory content, and the UUID of the created link and/or the UUID of the directory where the created link is located is added to the record. A record is further added to the directory content of the directory where the link to be created is located to indicate the UUID, link name, attribute information, etc. assigned to the link to be created; and the target UUID and/or the target parent UUID pointed to by the created link are also indicated in the added record (1148). Optionally, there is no need to use the UUID of the created link to access the KV storage device.

FIG. 11E shows the process of providing a directory creation service by a file system. To create a directory, a file system path of the directory to be created is provided to the file system, including the directory where the directory to be created is located (parent directory) and the name of the directory to be created (1150). The file system obtains the file system path of a parent directory from the received file system path, and identifies whether the parent directory exists (1152). In step 1152, if the parent directory does not exist, the file system indicates to the user or application that an error occurs (1159). In step 1152, if the parent directory exists, the UUID of the parent directory is obtained, and the UUID is used to access the KV storage device to obtain the parent directory content (1154). The name of the directory to be created is used to search for records in the parent directory content obtained in step 1154 to identify whether there is a record associated with the directory name of the directory to be created in the parent directory content (1156). If the directory name of the directory to be created is found in step 1156, the occurrence of an error is indicated to the user or the file system (1159). If the record corresponding to the directory to be created is not found in step 1156, a record is added to the parent directory content of the directory to be created to indicate the UUID, the directory name, the attribute information, etc. assigned to the directory to be created (1158).

FIG. 11F shows the process of providing a directory deletion service by a file system. To delete a directory, a file system path of the directory to be deleted is provided to the file system, including the file system path of a parent directory of the directory to be deleted and the name of the directory to be deleted (1160). The file system obtains the parent directory of the directory to be deleted from the received parent directory file system path, and identifies whether the parent directory exists (1161). In step 1161, if the parent directory does not exist, the file system indicates to the user or the application that an error occurs (1169) because the directory to be deleted does not exist. In step 1161, if the parent directory exists, the UUID of the parent directory is obtained, and the UUID is used to access the KV storage device to obtain parent directory content (1162). The directory name of the directory to be deleted is used to search for records in the parent directory content obtained in step 1162 to identify whether there is a record associated with the directory name of the directory to be deleted in the parent directory content (1163). If the directory to be deleted is not found in step 1163, it is indicated to the user or the file system that the directory to be deleted does not exist (1169). If the record corresponding to the directory to be deleted is found in step 1163, the UUID of the directory to be deleted is obtained from the record, and the UUID is used to access the KV storage device to obtain the directory content to be deleted of the directory to be deleted (1164). Each record of the directory content to be deleted is traversed. If the directory content to be deleted indicates that the directory to be deleted is empty (for example, there are only the record corresponding to the directory to be deleted itself and the record corresponding to the parent directory of the directory to be deleted), the KV storage device is accessed through the UUID of the directory to be deleted to delete the directory content to be deleted, and the parent directory content of the directory to be deleted is updated, and the record related to the directory to be deleted is deleted therefrom (1166).

If the directory content to be deleted indicates that the directory to be deleted also includes subdirectories and/or files, each subdirectory and file is deleted (1167). For example, to delete the subdirectories, the process from step 1160 is repeated; and to delete the files, the process shown in FIG. 11B is implemented.

FIG. 11G shows the process of providing a directory renaming service by a file system. To rename a directory, a file system path of the directory to be renamed is provided to the file system, including the file system path of a parent directory of the directory to be renamed, the name of the directory to be renamed, and a new directory name (1170). The file system obtains the parent directory of the directory to be renamed from the received parent directory file system path, and identifies whether the parent directory exists (1172). In step 1172, if the parent directory does not exist, the file system indicates to the user or the application that an error occurs (1179) because the directory to be renamed does not exist. In step 1172, if the parent directory exists, the UUID of the parent directory is obtained, and the UUID is used to access the KV storage device to obtain parent directory content (1174). The directory name of the directory to be renamed is used to search for records in the parent directory content obtained in step 1174 to identify whether there is a record associated with the directory name of the directory to be renamed in the parent directory content (1176). If the directory to be renamed is not found in step 1176, it is indicated to the user or the file system that the directory to be renamed does not exist (1179). If the record corresponding to the directory to be renamed is found in step 1176, the directory name in the record is changed to the new directory name (1178), i.e., the directory renaming is completed.

The file renaming service is implemented in a manner similar to that in FIG. 11G. In step 1176, if the record corresponding to the file to be renamed is found in the parent directory content, the file name in the record is modified to a new file name, i.e., the file renaming is completed.

FIG. 11H shows the process of providing a directory content listing service by a file system. To list directory content, the file system path of a directory for which the content is to be listed (referred to as a target directory) is provided to the file system, including the file system path of a parent directory of the target directory and the directory name of the target directory (1180). The file system obtains the parent directory of the target directory from the received parent directory file system path, and identifies whether the parent directory exists (1182). In step 1182, if the parent directory does not exist, the file system indicates to the user or the application that an error occurs (1189) because the target directory does not exist. In step 1182, if the parent directory exists, the UUID of the parent directory is obtained, and the UUID is used to access the KV storage device to obtain parent directory content (1184). The directory name of the target directory is used to search for records in the parent directory content obtained in step 1184 to identify whether there is a record associated with the directory name of the target directory in the parent directory content (1186). If the target directory is not found in step 1186, it is indicated to the user or the file system that the target directory does not exist (1189). If the record corresponding to the target directory is found in step 1186, the UUID of the target directory is obtained, and the UUID of the target directory is used to access the KV storage device to obtain target directory content, and each record of the target directory content is traversed to list all the objects (for example, subdirectories and files) included in the target directory.

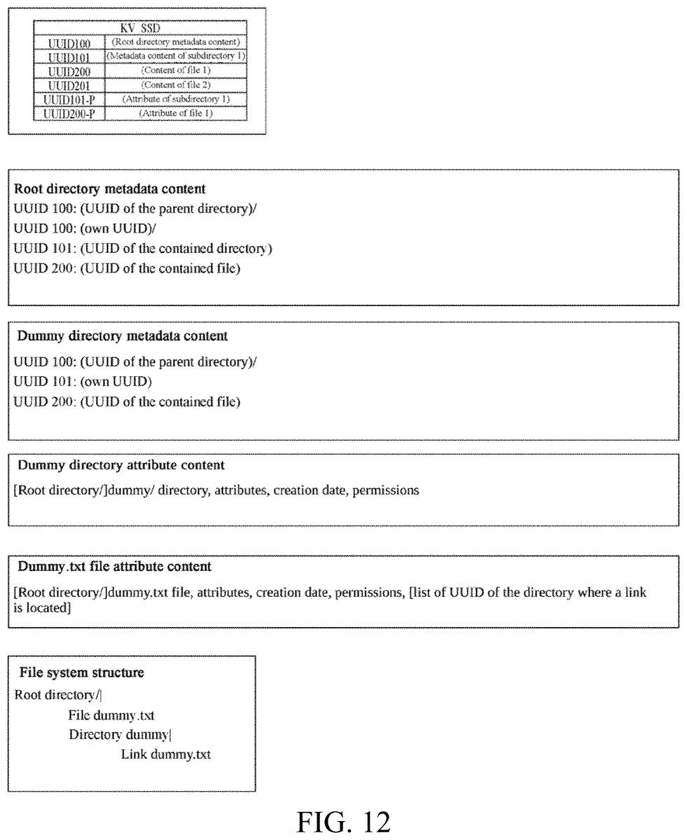

FIG. 12 is a schematic diagram of a file system based on a KV storage device according to still another embodiment of the present application.

The KV storage device records the key (K) and the corresponding value (V). The key is, for example, UUID, and the value is file content, directory metadata content, or directory attribute content. For example, the value corresponding to the key UUID 100 is metadata content of a root directory, the value corresponding to the key UUID 101 is the metadata content of subdirectory 1, the value corresponding to UUID 200 is the content of file 1, the value corresponding to the key UUID 201 is the content of file 2, the value corresponding to the key UUID 101+P is the attribute of subdirectory 1, and the value corresponding to UUID 200 is the attribute of file 1. According to the embodiment of FIG. 12, the metadata content and attributes of the same file system object (file or directory) are indexed by the associated key, for example, the metadata content of subdirectory 1 is indexed with the key UUID 101, and the attribute of subdirectory 1 is indexed with the key obtained by adding a specified suffix “P” to the key UUID 101. Therefore, if the key corresponding to subdirectory 1 is known, the key for accessing the attributes of subdirectory 1 can be obtained.

FIG. 12 also shows an exemplary file system structure. The root directory of the file system is “/”, which includes a subdirectory “dummy” and a file “dummy.txt”. The subdirectory “dummy” further includes a link to the file “dummy.txt” in the root directory.

FIG. 12 further shows the metadata content of the root directory, the metadata content of the subdirectory “dummy”, the attribute content of the subdirectory “dummy”, and the attribute content of the file “dummy.txt”.

The metadata content of the root directory is the value corresponding to the key UUID 100 recorded in the KV storage device. The root directory metadata content includes multiple records, and each record describes each key (UUID) of all files and subdirectories of the directory that is the root directory. The metadata content of the root directory in FIG. 12 includes four records. The first record (line 1) indicates the UUID (UUID 100) of the parent directory of the directory (root directory); and the second record (line 2) indicates its own UUID (UUID 100) of the directory (root directory). Because the “root directory” has no parent directory, its own UUID of the root directory is also recorded in the first record. The third record (line 3) indicates the UUID (UUID 101) of the object contained in the root directory. The fourth record (line 4) indicates the UUID (UUID 200) of the object contained in the root directory.

In the directory metadata according to the embodiment of FIG. 12, only UUID is recorded, and other information is not recorded.

Understandably, for each subdirectory and each file contained in the root directory, a corresponding record is provided in the metadata content of the root directory.

The metadata content of the directory “dummy” is the value corresponding to the key UUID 101 recorded in the KV storage device. The directory metadata content includes multiple records, and each record describes each UUID of all files and subdirectories where the directory is located. The metadata content of the subdirectory “dummy” in FIG. 12 includes three records. The first record (line 1) indicates the UUID of the parent directory of the subdirectory (subdirectory “dummy”) (UUID 100, which is the UUID of the root directory); the second record (line 2) indicates the UUID (UUID 101) of the directory (directory “dummy”); the third record (line 3) indicates the UUID of the objects contained in the directory (UUID 201). Understandably, each subdirectory and each file contained in the directory “dummy” has a corresponding record in the directory metadata content.

The directory attribute content of the directory “dummy” is the value corresponding to, for example, the key UUID 101 recorded in the KV storage device. The directory attribute content records its own name (“dummy”), its own type “directory”, its own related attributes, creation date, permissions, and the like. Optionally, the directory attribute content also records the UUIDs (UUID list) of the directories where one or more links pointing to itself are located in the file system. Optionally, in the directory attribute content, the name of the directory where the user is located is also recorded.

Optionally, there is no need to record the corresponding UUID in each entry of the directory attribute content, and the corresponding UUID is obtained by jointly querying the directory metadata content. For example, the records in the directory metadata content correspond one-to-one to the entries in the directory attribute content in order; thus the corresponding record in the directory metadata content is accessed according to the serial number of the record of the directory attribute content to obtain the corresponding UUID.

According to the file system shown in FIG. 12, the file has no corresponding metadata content, and the file has attribute content. The file attribute content of the file “dummy.txt” is the value corresponding to the key UUID 200+P recorded in the KV storage device. The file attribute content records its own name (“dummy.txt”), its own type “file”, its own related attributes, creation date, permissions, and the like. Optionally, the file attribute content also records the UUIDs (UUID list) of the directories where one or more links pointing to itself are located in the file system. Optionally, in the file attribute content, the name of the file where the user is located is also recorded.

To read a file from the file system according to the embodiment of FIG. 12, a file system path of the file to be read is provided to the file system, including the directory where the file is located and the file name. The file system acquires the directory where the file is located from the received file system path, and identifies whether the directory exists.

To identify whether the directory exists, the file system obtains the metadata content of the parent directory of the directory, and obtains the UUIDs of all objects contained in the parent directory from the metadata content of the parent directory. Moreover, the key (UUID+P) of the attribute content of the corresponding object is generated for each UUID, UUID+P is used to access the KV storage device to obtain the attribute content of the corresponding object, and whether the attribute content is the attribute content of the directory whose existence is to be identified is identified from the attribute content. If the attribute content of the directory whose existence is to be identified is found, it is determined that the directory exists. If the directory whose existence is to be identified is still not found even the attribute content of all the objects contained in the parent directory is traversed, it is determined that the directory does not exist.

Moreover, starting from the root directory, whether the parent directories of the directory to be accessed exist is identified by searching for the attribute content of the objects contained in the parent directories of the directory where the file is located step by step. The UUID of the root directory is, for example, known.

If the directory where the file to be accessed is located does not exist, the file system indicates to the user or the application that an error occurs because the file to be accessed does not exist. If the directory where the file to be accessed is located exists, the UUIDs of all the objects contained in the directory are acquired, and the key (UUID+P) of the attribute content of the corresponding object is generated for each UUID, the UUID+P is used to access the KV storage device to obtain the attribute content of the corresponding object, and whether the attribute content is the attribute content of the file to be accessed is identified from the attribute content.

If the attribute content of the file to be accessed is found, the UUID of the file to be accessed is obtained, and the KV storage device is accessed according to the UUID of the file to be accessed to read the content of file to be read.

To delete a file from the file system according to the embodiment of FIG. 12, a file system path of the file to be deleted is provided to the file system, including the directory where the file is located and the file name. The file system acquires the directory where the file is located from the received file system path, and identifies whether the directory exists.

If the directory where the file to be accessed is located does not exist, the file system indicates to the user or the application that an error occurs because the file to be accessed does not exist. If the directory where the file to be accessed is located exists, the UUIDs of all the objects contained in the directory are acquired, and the key (UUID+P) of the attribute content of the corresponding object is generated for each UUID, the UUID+P is used to access the KV storage device to obtain the attribute content of the corresponding object, and whether the attribute content is the attribute content of the file to be deleted is identified from the attribute content.

If the attribute content of the file to be deleted is found, the UUID of the file to be deleted is obtained, and the KV storage device is accessed according to the UUID of the file to be deleted to delete the content of file to be read.

To rename a directory from the file system according to the embodiment of FIG. 12, a file system path of the directory to be renamed is provided to the file system, including a directory where directory to be renamed is located (the parent directory), the directory name of the directory to be renamed, and a new directory name. The file system acquires the parent directory from the received file system path, and identifies whether the parent directory exists.

If the parent directory does not exist, the file system indicates to the user or application that an error occurs. If the parent directory exists, the UUIDs of all the objects contained in the parent directory are acquired, and the key (UUID+P) of the attribute content of the corresponding object is generated for each UUID, the UUID+P is used to access the KV storage device to obtain the attribute content of the corresponding object, and whether the attribute content is the attribute content of the file to be renamed is identified from the attribute content.

If the attribute content of the directory to be renamed is found, the file name recorded therein is modified to the new file name to complete the directory renaming operation.

According to the embodiments described above, those skilled in the art would easily obtain the implementation mode of performing operations, such as file modification, link creation, link deletion, directory creation, directory deletion, and directory content listing, by the file system according to the embodiment of FIG. 12.

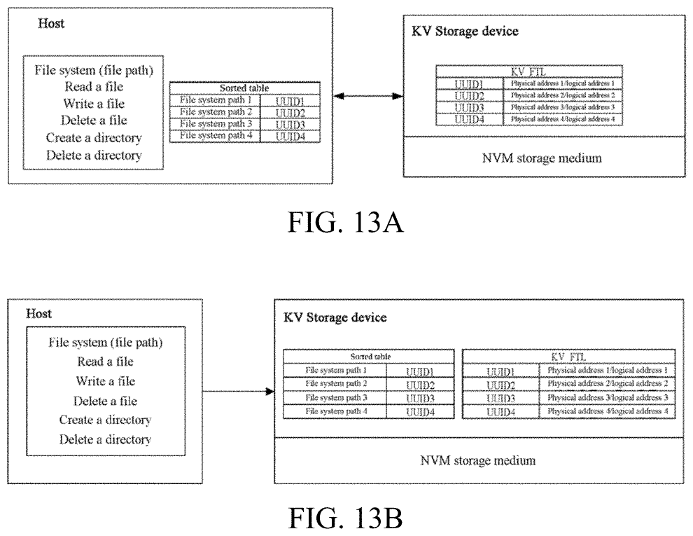

FIG. 13A is a schematic diagram of a KV storage device based on a logical key according to another embodiment of the present application. According to the embodiment of FIG. 13A, the file system according to the embodiment of FIG. 12 is accelerated.

Referring to FIG. 13A, the host running the file system is coupled with the KV storage device. The KV storage device provides a <key, value> service, wherein the key is, for example, UUID, and the value is, for example, file content, directory metadata content, directory attribute content, or file attribute content according to the embodiment of FIG. 12.

A sorted table is further maintained in the host running the file system, and the sorted table records the corresponding relationship between any file system path existing in the file system and the key (for example, UUID) used for the KV storage device. Through the sorted table, the file system path serving as the logical key is mapped to the key (UUID). Therefore, to access the file system (file content, directory metadata content, directory attribute content or file attribute content), according to the file system path, the UUID corresponding to the file system path can be quickly searched from the sorted table, the UUID corresponding to the file system path can be quickly queried from the sorted table according to the file system path to find the directory where the target object to be accessed located without traversing the file system, and the directory is further traversed to obtain the process of obtaining the UUID of the object to be accessed. According to the file system path of the object to be accessed, the file system path of the directory where the object to be accessed is located can also be easily obtained, and the UUID corresponding to the file system path of the directory where the object to be accessed is located can also be quickly obtained from the sorted table. The sorted table is maintained by the host running the file system. The file system accesses the KV storage device according to the acquired UUID, in order to access the file content, directory attribute content, or file attribute content of the accessed file system.

Furthermore, for operations that cause modification of the file system path (such as, file or directory renaming), a flag (for example, locking) is set for the sorted table to indicate that the sorted table node corresponding to the modified file or directory is to be modified, and also to indicate the sorted table nodes corresponding to all the sub-directories of the directory to be modified. When accessing the sorted table, if the visited node is set with a flag, the file system is traversed according to the to-be-accessed file system path according to the method shown in the embodiment of FIG. 12. Moreover, the sorted table is further updated to reflect the modification to the file system path. In response to the completion of the update of the sorted table, the flag set for the sorted table is revoked. It is advantageous to store an acceleration table in a prefix tree, thereby facilitating the modification of an acceleration table node.

FIG. 13B is a schematic diagram of a KV storage device based on a logical key according to still another embodiment of the present application. According to the embodiment of FIG. 13B, the file system according to the embodiment of FIG. 12 is accelerated.

In one implementation mode, the KV storage device provides a sorted table service that can be accessed by the file system of the host. The file system path is used as the key to access the KV storage system (or the key of the sorted table service), and the UUID of the node in the accelerator table is used as the value of the KV storage system (or the value corresponding to the file system path provided by the sorted table service).

The file system running on the host accesses the sorted table by means of the KV storage device. To access the file system (file content, directory metadata content, directory attribute content or file attribute content), the file system path is provided to the sorted table service of the KV storage device. The sorted table service of the KV storage device outputs the UUID corresponding to the file system path as a response, thereby finding the directory where the target object to be accessed is located without traversing the file system, and the directory is further traversed to obtain the process of obtaining the UUID of the object to be accessed.

The file system running on the host accesses the file content, directory metadata content, directory attribute content, or file attribute content in the manner provided in the embodiment shown in FIG. 12 on the basis of the obtained UUID to provide a file system service.

Furthermore, in response to the operation of creating a file or creating a directory, the file system further adds an entry to the sorted table, and the added entry records the corresponding relationship between the file system path of the created file or directory and the newly assigned UUID. The UUID may be assigned by the file system or the KV storage device.

Furthermore, in response to the operation of writing a file, the file system acquires the UUID corresponding to the file system path from the sorted table, and updates the value corresponding to the UUID in the KV storage device. Moreover, optionally, the attribute information of the updated file corresponding to, for example, “UUID+P” recorded in the KV storage device is further updated.

Still furthermore, in response to the operation of modifying the file name, the file system further modifies the entry in the sorted table to find an entry corresponding to the file system path corresponding to the unmodified file name from the sorted table, and updates the file system path thereof.

Still furthermore, in response to the operation of modifying the directory name, the file system modifies the entries in the sorted table corresponding to the modified directory, and further modifies the entries of all objects contained in the modified directory in the sorted table. For example, for the subdirectory “dummy!” of the root directory, the full path is “/dummy”, which includes a subdirectory “dummy1/” and a file “dummy1.txt”. In response to the name of the subdirectory “dummy!” being modified to “dummyNew!”, in addition to modifying its own records in the sorted table, the records of the subdirectory “dummy1/” and the file “dummy1.txt” in the sort table are also modified, because the file system path has changed. Because there are lots of entries to be modified in the sorted table, a period of time is required for processing, and before the modification is completed, the sorted table does not respond to the access to the modified entries. For example, in response to an entry of a sorted table to be modified, the sorted table is locked, or the modified entry of the sorted table is locked, thereby preventing access to the entry of the sorted table that is being modified. Moreover, the file system traverses the file system (the directory metadata content and directory attribute content) according to the to-be-accessed file system path according to the method shown in the embodiment of FIG. 12 to acquire the UUID corresponding to the file system path.

In another implementation mode, the KV storage device provides a sorted table service in the form of <key, value>. The file system path of the entry in the sorted table is used as the key to access the KV storage system, and the UUID of the entry in the sorted table is used as the value of the KV storage system.

Still optionally, the KV storage device implements the sorted table by using a prefix tree.

According to the embodiments of the present application, further provided is a solid-state storage device. The device includes a controller and a non-volatile memory chip, wherein the controller executes any one of the processing methods provided by the embodiments of the present application.

According to the embodiments of the present application, further provided is a program stored on a readable medium, wherein when the program is run by a controller of a solid-state storage device, the solid-state storage device executes any one of the processing methods according to the embodiments of the present application.

Although the preferred embodiments of the present application have been described, those skilled in the art benefiting from the underlying inventive concept can make additional alterations and modifications to these embodiments. Therefore, the appended claims are intended to be interpreted as encompassing the preferred embodiments and all the alterations and modifications falling within the scope of the present application. Apparently, those skilled in the art can make various changes and variations to the present application without departing from the spirit and the scope of the present application. In this way, if these changes and variations of the present application fall within the scope of the claims of the present invention and equivalent technologies thereof, the present application is also intended to include these changes and variations.

1-16. (canceled)

17. A method for a KV storage device, comprising:
receiving a logical key for accessing the KV storage device;
acquiring a physical key corresponding to the logical key; and
querying an address translation table to obtain an address corresponding to the physical key, and a value corresponding to the logical key is stored in the address;
wherein
querying a first table of the KV storage device to acquire the physical key corresponding to the logical key, wherein the first table is a sorted table.

18. The method according to claim 17, wherein
performing a hash calculation on the physical key to obtain a hash key; and
accessing a hash table with the hash key as an index, to obtain the address corresponding to the physical key.

19. The method according to one of claim 18, wherein
in response to writing a value corresponding to the logical key to the KV storage device, if the physical key corresponding to the logical key is not found in the first table, assigning a physical key to the logical key, adding an entry to the first table to record the logical key corresponding to the assigned physical key, and assigning an address to the assigned physical key; and adding an entry to the address translation table to record the physical key and the assigned address, and writing the value corresponding to the logical key at the assigned address.

20. The method according to claim 19, wherein
in response to instructing the KV storage device to modify the logical key, finding an entry corresponding to the logical key in the first table, and modifying the entry to record a new logical key modified.

21. The method according to any one of claim 20, wherein
in response to instructing the KV storage device to copy the value corresponding to the logical key, finding a first physical key corresponding to the logical key in the first table, and adding an entry to the first table to record a new logical key corresponding to the first physical key.

22. A method of using a KV storage device to provide a file system, comprising:
acquiring a file system path of a file system object to be accessed;
acquiring a key corresponding to the file system path; and
accessing a value corresponding to the key in the KV storage device by using the key, wherein the value is an object in the file system corresponding to the file system path; wherein
the KV storage device provides a sorted table, and the file system acquires the key corresponding to the file system path by accessing the sorted table of the KV storage device.

23. The method according to claim 22, wherein
the KV storage device provides the sorted table with a storage service of <key, value>, wherein the file system path recorded in an entry of the sorted table is used as the key of the KV storage device, and the key corresponding to the file system path recorded in the entry of the sorted table is used as the value of the KV storage device.

24. The method according to one of claim 23, wherein
the object of the file system comprises a file content and a directory content;
the directory content comprises keys and names of subdirectories and keys and names of files contained in the directory; and
the method further comprises: acquiring a first directory, where the file system object to be accessed is located, through the file system path; and
accessing the directory content of the first directory from the KV storage device through the key of the first directory, and acquiring the key of the file system object to be accessed from the directory content of the first directory.

25. The method according to one of claim 23, wherein
the object of the file system comprises a file content, a directory metadata, and a directory attribute content;
the directory metadata comprises keys of subdirectories and keys of files contained in the directory;
the directory metadata comprises names of the subdirectories and names of the files contained in the directory; and
the method further comprises: acquiring a first directory, where the file system object to be accessed is located, through the file system path; acquiring a key of the directory metadata of the first directory and a key of a directory attribute of the first directory through the key of the first directory; and accessing the directory metadata and the directory attribute of the first directory from the KV storage device, to acquire the key of the file system object to be accessed.

26. The method according to claim 24, further comprising:
in response to creating a file in the file system, assigning a key used in the KV storage device to the file to be created, and recording the key assigned to the file to be created and the name of the file to be created in the directory content of the first directory.

27. The method according to claim 24, further comprising:
in response to modifying the name of the file system object in the file system, updating the name of the file system object to be modified recorded in the directory content of the first directory.

28. The method according to claim 24, further comprising:
in response to deleting a directory in the file system, deleting all subdirectories of the directory to be deleted, and acquiring the keys of all files contained in the directory to be deleted from the content of the directory of the directory to be deleted, using the acquired keys to delete the corresponding file content from the KV storage device, and delete an entry corresponding to the directory to be deleted recorded in the content of the directory of the first directory.

29. The method according to claim 24, further comprising:
in response to creating a file in the file system, assigning a key used in the KV storage device to the file to be created, recording the key assigned to the file to be created in the directory metadata of the first directory, and recording the name of the file to be created in the directory attribute content of the first directory.

30. The method according to claim 24, further comprising:
in response to modifying the name of the file system object, locking the entry corresponding to the file system path associated with the file system object to be modified in the sorted table; and
updating the file system path of one or more entries associated with the modified file system object recorded in the sorted table;
in response to the completion of the update of the sorted table, releasing the added lock.

31. The method according to claim 30, further comprising:
in response to accessing the object of the file system, if the file system path of the object to be accessed is locked in the file system, accessing the first directory from the KV storage device to obtain the key of the file system object to be accessed.

32. A KV storage device, comprising a control component and a non-volatile storage medium, wherein the control component executes the method according to 17.
